(19) United States
(12) Patent Application Publication
(10) Pub. No.: US 2025/0063592 A1
(43) Pub. Date: Feb. 20, 2025

(54) TECHNIQUES FOR PROVISIONING UAV-TO-EVERYTHING PARAMETERS

(71) Applicant: QUALCOMM INCORPORATED, San Diego, CA (US)

(72) Inventors: Kefeng Zhang, Beijing (CN); Stefano Faccin, San Ysidro, CA (US); Drew Foster Van Duren, Templeton, CA (US)

(21) Appl. No.: 18/720,573

(22) PCT Filed: Feb. 16, 2022
(86) PCT No.: PCT/CN2022/076399

§ 371 Date: Jun. 14, 2024

(51) Int. Cl. H04W 72/566; H04B 7/185; H04W 72/25

(52) U.S. Cl. CPC H04W 72/566; H04B 7/18504; H04W 72/25

(57) ABSTRACT

Methods, systems, and devices for wireless communications are described. Specifically, techniques and signaling for configuring and utilizing parameters for unmanned aerial vehicle (UAV)-to-everything (U2X) communications are described, including registration procedures for U2X communications. A user equipment (UE), such as a UAV, may receive control signaling indicating a UE policy configuration including a set of radio parameters usable by the UE to perform sidelink communications to support one or more UAV services. The UE may receive an altitude limitation parameter associated with the one or more UAV services via the control signaling, additional control signaling, or both. The UE may then perform a sidelink message associated with the one or more UAV services in accordance with the UE policy configuration and altitude limitation parameter.

### CROSS REFERENCE

The present application is a 371 national stage filing of International PCT Application No. PCT/CN2022/076399 by Zhang et al. entitled “TECHNIQUES FOR PROVISIONING UAV-TO-EVERYTHING PARAMETERS,” filed Feb. 16, 2022, which is assigned to the assignee hereof, and which is expressly incorporated by reference in its entirety herein.

### FIELD OF TECHNOLOGY

The following relates to wireless communications, including techniques for provisioning unmanned aerial vehicle (UAV)-to-everything (U2X) parameters.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications support communications between wireless devices (e.g., UEs), which are referred to as sidelink communications. For example, some wireless communications systems support vehicle-to-everything (V2X) communications, in which vehicles (e.g., UEs) in a system can communicate with other wireless devices, including roadside infrastructure such as roadside units. Some wireless communications systems may also include unmanned aerial vehicles (UAVs) which support UAV services. However, subscription information for V2X is does not apply to UAV-to-everything (U2X) services due to the different requirements of the service types, applications, policy and quality of service (QOS) requirements, and radio parameters.

### SUMMARY

The described techniques relate to improved methods, systems, devices, and apparatuses that support techniques for provisioning U2X parameters. Generally, aspects of the present disclosure support signaling and for indicating and configuring parameters for unmanned aerial vehicle (UAV)-to-everything (U2X) services. In particular, aspects of the present disclosure support new configurations and signaling used to configure user equipments (UEs) with U2X parameters, rules for which U2X parameters are provided to UEs, and techniques for using U2X parameters at the UEs. Moreover, aspects of the present disclosure support rules and priorities for applying U2X parameters in cases where a UE is, and is not, configured with a subscriber identity module (SIM) card. For example, a UE may be have with a UE policy configuration including radio parameters for U2X services, where the policy configuration includes an “altitude limitation parameter” for the U2X services. In such cases, the UE can perform U2X communications in accordance with the UE policy configuration and the altitude limitation parameter. For instance, the UE may be authorized to perform U2X services only when the UE is at an altitude that satisfies the altitude limitation parameter.

A method for wireless communication at a UE is described. The method may include receiving control signaling indicating a UE policy configuration including a set of radio parameters usable by the UE to perform sidelink communications to support one or more UAV services, receiving, via the control signaling, additional control signaling, or both, an altitude limitation parameter associated with the one or more UAV services, and communicating a sidelink message associated with the one or more UAV services in accordance with the UE policy configuration and altitude limitation parameter.

An apparatus for wireless communication at a UE is described. The apparatus may include a processor, memory coupled with the processor, and instructions stored in the memory. The instructions may be executable by the processor to cause the apparatus to receive control signaling indicating a UE policy configuration including a set of radio parameters usable by the UE to perform sidelink communications to support one or more UAV services, receive, via the control signaling, additional control signaling, or both, an altitude limitation parameter associated with the one or more UAV services, and communicate a sidelink message associated with the one or more UAV services in accordance with the UE policy configuration and altitude limitation parameter.

Another apparatus for wireless communication at a UE is described. The apparatus may include means for receiving control signaling indicating a UE policy configuration including a set of radio parameters usable by the UE to perform sidelink communications to support one or more UAV services, means for receiving, via the control signaling, additional control signaling, or both, an altitude limitation parameter associated with the one or more UAV services, and means for communicating a sidelink message associated with the one or more UAV services in accordance with the UE policy configuration and altitude limitation parameter.

A non-transitory computer-readable medium storing code for wireless communication at a UE is described. The code may include instructions executable by a processor to receive control signaling indicating a UE policy configuration including a set of radio parameters usable by the UE to perform sidelink communications to support one or more UAV services, receive, via the control signaling, additional control signaling, or both, an altitude limitation parameter associated with the one or more UAV services, and communicate a sidelink message associated with the one or more UAV services in accordance with the UE policy configuration and altitude limitation parameter.

Some examples of the method, apparatuses, and non-transitory computer-readable medium described herein may further include operations, features, means, or instructions for identifying an altitude associated with the UE, where communicating the sidelink message may be based on the identified altitude satisfying the altitude limitation parameter.

In some examples of the method, apparatuses, and non-transitory computer-readable medium described herein, the altitude limitation parameter includes an altitude range associated with an authorization for the one or more UAV services and the identified altitude satisfies the altitude limitation parameter if the identified altitude may be within the altitude range.

Some examples of the method, apparatuses, and non-transitory computer-readable medium described herein may further include operations, features, means, or instructions for identifying a conflict between a first radio parameter from the set of radio parameters and a second radio parameter from an additional set of radio parameters and communicating the sidelink message in accordance with the first radio parameter based on a priority rule associated with conflicts between the set of radio parameters and the additional set of radio parameters.

Some examples of the method, apparatuses, and non-transitory computer-readable medium described herein may further include operations, features, means, or instructions for receiving, via the control signaling, the additional control signaling, or both, an indication of one or more priority rules associated with conflicts between the set of radio parameters one or more additional radio parameters, the one or more priority rules including the priority rule, where identifying the conflict, communicating the sidelink message, or both, may be based on the one or more priority rules.

In some examples of the method, apparatuses, and non-transitory computer-readable medium described herein, the one or more priority rules may be associated with a first source of the set of radio parameters and a second source of the additional set of radio parameters and the one or more priority rules prioritize radio parameters provided by a policy control function over radio parameters provided by an application server, prioritize radio parameters provided by the application server over radio parameters provided by a SIM, and prioritize radio parameters provided by the SIM over radio parameters configured at the UE.

Some examples of the method, apparatuses, and non-transitory computer-readable medium described herein may further include operations, features, means, or instructions for identifying an additional set of radio parameters usable by the UE to perform sidelink communications to support the one or more UAV services based on a SIM associated with the UE, where communicating the sidelink message may be based on the additional set of radio parameters.

Some examples of the method, apparatuses, and non-transitory computer-readable medium described herein may further include operations, features, means, or instructions for receiving, via the control signaling, the additional control signaling, or both, an indication of one or more radio access technologies (RATs) associated with the UE policy configuration, where the sidelink message may be communicated in accordance with the one or more RATs.

Some examples of the method, apparatuses, and non-transitory computer-readable medium described herein may further include operations, features, means, or instructions for receiving, via the control signaling, the additional control signaling, or both, an authorization to perform the one or more UAV services in accordance with the UE policy configuration and the one or more RATs, where the one or more RATs include a Fourth Generation (4G) RAT, a Long-Term Evolution (LTE) RAT, a Fifth Generation (5G) RAT, a New Radio (NR) access technology, or any combination thereof, and where communicating the sidelink message may be based on the authorization.

Some examples of the method, apparatuses, and non-transitory computer-readable medium described herein may further include operations, features, means, or instructions for receiving, via the control signaling, the additional control signaling, or both, a first authorization for the UE to perform the one or more UAV services in accordance with the UE policy configuration during time intervals in which the UE may be connected to a serving network, a second authorization for the UE to perform the one or more UAV services in accordance with the UE policy configuration during time intervals in which the UE may be not connected to the serving network, or both, where communicating the sidelink message may be based on the first authorization, the second authorization, or both.

Some examples of the method, apparatuses, and non-transitory computer-readable medium described herein may further include operations, features, means, or instructions for receiving, via the control signaling, the additional control signaling, or both, an indication of one or more RATs associated with the one or more UAV services, where the sidelink message may be communicated in accordance with the one or more RATs.

Some examples of the method, apparatuses, and non-transitory computer-readable medium described herein may further include operations, features, means, or instructions for receiving, via the control signaling, the additional control signaling, or both, an indication of a first RAT associated with a first subset of the one or more UAV services, and a second RAT associated with a second subset of the one or more UAV services, where the one or more RATs include the first and second RAT.

Some examples of the method, apparatuses, and non-transitory computer-readable medium described herein may further include operations, features, means, or instructions for receiving, via the control signaling, the additional control signaling, or both, an indication of one or more privacy parameters associated with the one or more UAV services, one or more geographical areas, or both, where the sidelink message may be communicated in accordance with the one or more privacy parameters.

Some examples of the method, apparatuses, and non-transitory computer-readable medium described herein may further include operations, features, means, or instructions for receiving, via the control signaling, the additional control signaling, or both, an indication of a privacy timer value associated with the UE policy configuration, where the sidelink message may be communicated in accordance with the privacy timer value.

Some examples of the method, apparatuses, and non-transitory computer-readable medium described herein may further include operations, features, means, or instructions for receiving, via the control signaling, the additional control signaling, or both, an indication of a validity timer associated with the UE policy configuration, the set of radio parameters, or both, where communicating the sidelink message may be based on the validity timer.

Some examples of the method, apparatuses, and non-transitory computer-readable medium described herein may further include operations, features, means, or instructions for identifying an expiration of the validity timer and refraining from performing sidelink communications in accordance with the UE policy configuration based on the expiration of the validity timer.

Some examples of the method, apparatuses, and non-transitory computer-readable medium described herein may further include operations, features, means, or instructions for receiving, via the control signaling, the additional control signaling, or both, an indication of a set of mappings between the one or more UAV services and corresponding subsets of the set of radio parameters, where each subset of the set of radio parameters includes at least one of a frequency range, a geographical area, an altitude range, a mode of communication, a Layer 2 (L2) identifier, a sidelink quality of service (QOS) metric, a radio bearer, a discontinuous reception (DRX) cycle, or any combination thereof, where communicating the sidelink message may be based on the set of mappings.

Some examples of the method, apparatuses, and non-transitory computer-readable medium described herein may further include operations, features, means, or instructions for receiving the control signaling, the additional control signaling, or both, from at least one of a network device or a second UE.

Some examples of the method, apparatuses, and non-transitory computer-readable medium described herein may further include operations, features, means, or instructions for receiving, via the control signaling, the additional control signaling, or both, an indication as to whether the set of radio parameters may be operator-managed, non-operator-managed, or both, where communicating the sidelink message may be based on the indication.

In some examples of the method, apparatuses, and non-transitory computer-readable medium described herein, one or more UAV services include one or more U2X communications services.

A method for wireless communication is described. The method may include transmitting, to a UE, control signaling indicating a UE policy configuration including a set of radio parameters usable by the UE to perform sidelink communications to support one or more UAV services, transmitting, via the control signaling, additional control signaling, or both, an altitude limitation parameter associated with the one or more UAV services, and updating a subscription associated with the UE based on the altitude limitation parameter.

An apparatus for wireless communication is described. The apparatus may include a processor, memory coupled with the processor, and instructions stored in the memory. The instructions may be executable by the processor to cause the apparatus to transmit, to a UE, control signaling indicating a UE policy configuration including a set of radio parameters usable by the UE to perform sidelink communications to support one or more UAV services, transmit, via the control signaling, additional control signaling, or both, an altitude limitation parameter associated with the one or more UAV services, and update a subscription associated with the UE based on the altitude limitation parameter.

Another apparatus for wireless communication is described. The apparatus may include means for transmitting, to a UE, control signaling indicating a UE policy configuration including a set of radio parameters usable by the UE to perform sidelink communications to support one or more UAV services, means for transmitting, via the control signaling, additional control signaling, or both, an altitude limitation parameter associated with the one or more UAV services, and means for updating a subscription associated with the UE based on the altitude limitation parameter.

A non-transitory computer-readable medium storing code for wireless communication is described. The code may include instructions executable by a processor to transmit, to a UE, control signaling indicating a UE policy configuration including a set of radio parameters usable by the UE to perform sidelink communications to support one or more UAV services, transmit, via the control signaling, additional control signaling, or both, an altitude limitation parameter associated with the one or more UAV services, and update a subscription associated with the UE based on the altitude limitation parameter.

In some examples of the method, apparatuses, and non-transitory computer-readable medium described herein, the altitude limitation parameter includes an altitude range associated with an authorization for the one or more UAV services and an altitude associated with the UE satisfies the altitude limitation parameter if the altitude may be within the altitude range.

Some examples of the method, apparatuses, and non-transitory computer-readable medium described herein may further include operations, features, means, or instructions for transmitting, via the control signaling, the additional control signaling, or both, an indication of one or more priority rules associated with conflicts between the set of radio parameters one or more additional radio parameters.

In some examples of the method, apparatuses, and non-transitory computer-readable medium described herein, the one or more priority rules may be associated with a first source of the set of radio parameters and a second source of the additional set of radio parameters and the one or more priority rules prioritize radio parameters provided by a policy control function over radio parameters provided by an application server, prioritize radio parameters provided by the application server over radio parameters provided by a SIM, and prioritize radio parameters provided by the SIM over radio parameters configured at the UE.

Some examples of the method, apparatuses, and non-transitory computer-readable medium described herein may further include operations, features, means, or instructions for transmitting, via the control signaling, the additional control signaling, or both, an indication of one or more RATs associated with the UE policy configuration.

Some examples of the method, apparatuses, and non-transitory computer-readable medium described herein may further include operations, features, means, or instructions for transmitting, via the control signaling, the additional control signaling, or both, an authorization to perform the one or more UAV services in accordance with the UE policy configuration and the one or more RATs, where the one or more RATs include a 4G RAT, an LTE RAT, a 5G RAT, an NR RAT, or any combination thereof.

Some examples of the method, apparatuses, and non-transitory computer-readable medium described herein may further include operations, features, means, or instructions for transmitting, via the control signaling, the additional control signaling, or both, a first authorization for the UE to perform the one or more UAV services in accordance with the UE policy configuration during time intervals in which the UE may be connected to a serving network, a second authorization for the UE to perform the one or more UAV services in accordance with the UE policy configuration during time intervals in which the UE may be not connected to the serving network, or both.

Some examples of the method, apparatuses, and non-transitory computer-readable medium described herein may further include operations, features, means, or instructions for transmitting, via the control signaling, the additional control signaling, or both, an indication of one or more RATs associated with the one or more UAV services.

Some examples of the method, apparatuses, and non-transitory computer-readable medium described herein may further include operations, features, means, or instructions for transmitting, via the control signaling, the additional control signaling, or both, an indication of a first RAT associated with a first subset of the one or more UAV services, and a second RAT associated with a second subset of the one or more UAV services, where the one or more RATs include the first and second RAT.

Some examples of the method, apparatuses, and non-transitory computer-readable medium described herein may further include operations, features, means, or instructions for receiving, via the control signaling, the additional control signaling, or both, an indication of one or more privacy parameters associated with the one or more UAV services, one or more geographical areas, or both, where the sidelink message may be communicated in accordance with the one or more privacy parameters.

Some examples of the method, apparatuses, and non-transitory computer-readable medium described herein may further include operations, features, means, or instructions for transmitting, via the control signaling, the additional control signaling, or both, an indication of a privacy timer value associated with the UE policy configuration.

Some examples of the method, apparatuses, and non-transitory computer-readable medium described herein may further include operations, features, means, or instructions for transmitting, via the control signaling, the additional control signaling, or both, an indication of a validity timer associated with the UE policy configuration, the set of radio parameters, or both.

Some examples of the method, apparatuses, and non-transitory computer-readable medium described herein may further include operations, features, means, or instructions for transmitting, via the control signaling, the additional control signaling, or both, an indication of a set of mappings between the one or more UAV services and corresponding subsets of the set of radio parameters, where each subset of the set of radio parameters includes at least one of a frequency range, a geographical area, an altitude range, a mode of communication, an L2 identifier, a sidelink QoS metric, a radio bearer, a DRX cycle, or any combination thereof, where communicating the sidelink message may be based on the set of mappings.

Some examples of the method, apparatuses, and non-transitory computer-readable medium described herein may further include operations, features, means, or instructions for transmitting, via the control signaling, the additional control signaling, or both, an indication as to whether the set of radio parameters may be operator-managed, non-operator-managed, or both.

In some examples of the method, apparatuses, and non-transitory computer-readable medium described herein, one or more UAV services include one or more U2X communications services.

### BRIEF DESCRIPTION OF THE DRAWINGS

FIG. 1 illustrates an example of a wireless communications system that supports techniques for provisioning unmanned aerial vehicle (UAV)-to-everything (U2X) parameters in accordance with one or more aspects of the present disclosure.

FIG. 2 illustrates an example of a wireless communications system that supports techniques for provisioning U2X parameters in accordance with one or more aspects of the present disclosure.

FIG. 3 illustrates an example of a wireless communications system that supports techniques for provisioning U2X parameters in accordance with one or more aspects of the present disclosure.

FIG. 4 illustrates an example of a process flow that supports techniques for provisioning U2X parameters in accordance with one or more aspects of the present disclosure.

FIGS. 5 and 6 show block diagrams of devices that support techniques for provisioning U2X parameters in accordance with one or more aspects of the present disclosure.

FIG. 7 shows a block diagram of a communications manager that supports techniques for provisioning U2X parameters in accordance with one or more aspects of the present disclosure.

FIG. 8 shows a diagram of a system including a device that supports techniques for provisioning U2X parameters in accordance with one or more aspects of the present disclosure.

FIGS. 9 and 10 show block diagrams of devices that support techniques for provisioning U2X parameters in accordance with one or more aspects of the present disclosure.

FIG. 11 shows a block diagram of a communications manager that supports techniques for provisioning U2X parameters in accordance with one or more aspects of the present disclosure.

FIG. 12 shows a diagram of a system including a device that supports techniques for provisioning U2X parameters in accordance with one or more aspects of the present disclosure.

FIGS. 13 through 16 show flowcharts illustrating methods that support techniques for provisioning U2X parameters in accordance with one or more aspects of the present disclosure.

### DETAILED DESCRIPTION

Some wireless communications support communications between wireless devices (e.g., user equipments (UEs)), which are referred to as sidelink communications. For example, some wireless communications systems support vehicle-to-everything (V2X) communications, in which UEs associated with vehicles can communicate with other wireless devices, including roadside infrastructure such as roadside units. Some wireless communications systems may also support unmanned aerial vehicles (UAVs). Such UAVs may access or otherwise benefit from UAV-related services and communications related to (which may be referred to as UAV-to-everything (U2X) services and communications). Subscription information for V2X may not apply to UAV-to-everything (U2X) services due to the different requirements of the service types, applications, policy and quality of service (QOS) requirements, and radio parameters. As such, parameters for V2X communications services may be different from or inapplicable to U2X services, and separate U2X parameters need to be defined.

Accordingly, aspects of the present disclosure are directed to signaling which enables parameters for U2X services to be indicated and configured at UEs (e.g., UAVs). In particular, aspects of the present disclosure support configurations and signaling used to configure UEs with U2X parameters, rules for which U2X parameters are provided to UEs, and techniques for using U2X parameters at the UEs. In this regard, aspects of the present disclosure are directed to techniques for registration procedures between UEs (e.g., UAVs) and the network which are used to configure and/or update U2X parameters at the UEs. Moreover, aspects of the present disclosure are directed to rules and priorities for applying U2X parameters in cases where a UE is, or is not, configured with a subscriber identity module (SIM) card. For example, a UE is configured with a UE policy configuration including radio parameters for U2X services, where the policy configuration includes an “altitude limitation parameter” for the U2X services. In such cases, the UE can perform U2X communications in accordance with the UE policy configuration and the altitude limitation parameter. For instance, the UE may be authorized to perform U2X services when the UE is at an altitude that satisfies the altitude limitation parameter.

In some aspects, a UE may be configured with various priority rules in cases where the UE receives U2X radio parameters from different sources (e.g., policy control function (PCF), application server, SIM card, configured at UE). For example, U2X radio parameters configured via the PCF may be prioritized over radio parameters configured via the application server and/or SIM card. In some cases, a UE may be configured with different mappings between U2X services and different radio access technologies (RATs), frequency ranges, bandwidth parts (BWPs), and the like.

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to techniques for provisioning U2X parameters.

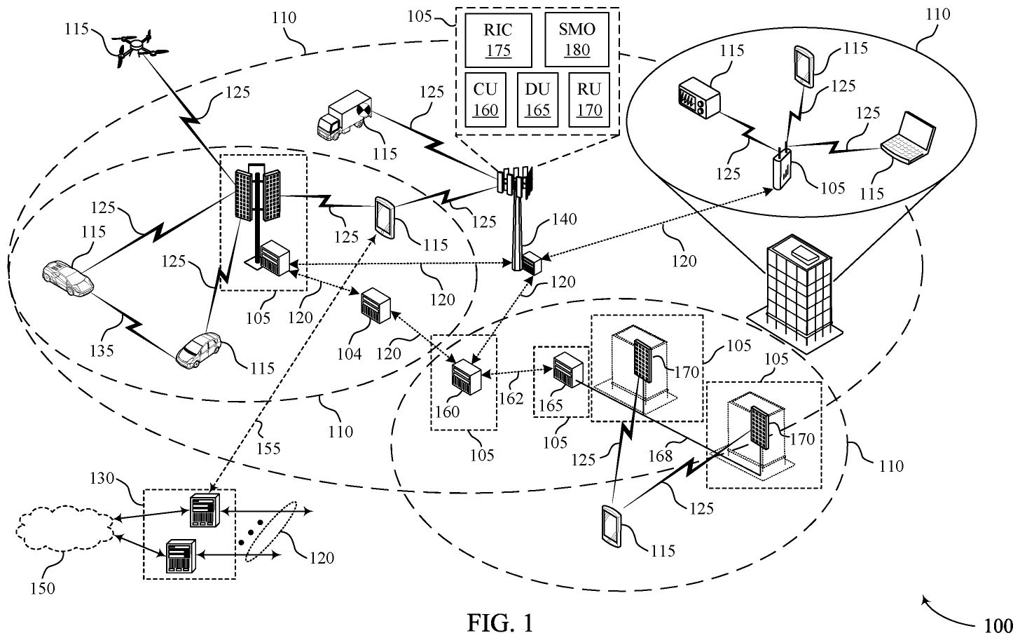

FIG. 1 illustrates an example of a wireless communications system 100 that supports techniques for provisioning U2X parameters in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In some examples, network entities 105 and UEs 115 may wirelessly communicate via one or more communication links 125. For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an access point, a radio transceiver, a NodeB, an eNodeB (eNB), a next-generation NodeB or a giga-NodeB (either of which may be referred to as a gNB), a next-generation eNB (ng-eNB), a Home NodeB, a Home eNodeB, or other suitable terminology). A network entity 105 (e.g., a base station 140) may be implemented in an aggregated or monolithic base station architecture, or alternatively, in a disaggregated base station architecture. For example, a network entity 105 may include one or more of a central unit (CU) 160, a distributed unit (DU) 165, a radio unit (RU) 170, a Radio Access Network (RAN) Intelligent Controller (RIC) 175 (e.g., a Near-Real Time RIC (Near-RT RIC), a Non-Real Time RIC (Non-RT RIC), a Service Management and Orchestration (SMO) 180 system, or any combination thereof. An RU 170 may also be referred to as a radio head, a smart radio head, a remote radio head (RRH), a remote radio unit (RRU), or a transmission/reception point (TRP). One or more components of the network entities 105 of a disaggregated RAN may be co-located, or one or more components of the network entities 105 may be located in distributed locations.

The split of functionality between a CU 160, a DU 165, and an RU 175 is flexible and may support different functionalities depending upon which functions (e.g., network layer functions, protocol layer functions, baseband functions, radio frequency functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an integrated access backhaul (IAB) network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 (e.g., one or more RUs 170) may be partially controlled by CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for provisioning U2X parameters as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 170, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (RAT) (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the radio frequency spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of a radio frequency spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and NA may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may utilize both licensed and unlicensed radio frequency spectrum bands. For example, the wireless communications system 100 may employ License Assisted Access (LAA), LTE-Unlicensed (LTE-U) RAT, or NR technology in an unlicensed band such as the 5 GHz industrial, scientific, and medical (ISM) band. While operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some aspects, the UEs 115 and the network entities 105 (e.g., base stations, network nodes) of the wireless communications system 100 may support signaling which enables parameters for U2X services to be indicated and configured at UEs 115 (e.g., UAVs). In particular, the wireless communications system 100 may support configurations and signaling used to configure UEs 115 with U2X parameters, rules for which U2X parameters are provided to UEs 115, and techniques for using U2X parameters at the UEs 115. In this regard, aspects of the present disclosure are directed to techniques for registration procedures between UEs 115 (e.g., UAVs) and the network which are used to configure and/or update U2X parameters at the UEs 115. Moreover, the wireless communications system 100 may be configured to support rules and priorities for applying U2X parameters in cases where a UE 115 is, or is not, configured with a SIM card. For example, a UE 115 may configured with a UE policy configuration including radio parameters for U2X services, where the policy configuration includes an “altitude limitation parameter” for the U2X services. In such cases, the UE 115 may be configured to perform U2X communications in accordance with the UE policy configuration and the altitude limitation parameter. For instance, the UE 115 may be authorized to perform U2X services only when the UE 115 is at an altitude that satisfies the altitude limitation parameter.

In some aspects, UEs 115 of the wireless communications system 100 may be configured with various priority rules in cases where the UEs 115 receive U2X radio parameters from different sources (e.g., PCF, application server, SIM card, configured at UE 115). For example, U2X radio parameters configured via the PCF may be prioritized over radio parameters configured via the application server and/or SIM card. In some cases, a UE 115 may be configured with different mappings between U2X services and different RATs, frequency ranges, BWPs, and the like.

Techniques described herein may enable registration procedures between UEs 115 (e.g., UAVs) and the network which are used to configure U2X parameters at the UEs 115, in particular, techniques described herein enable UEs 115 to be efficiently configured with U2X parameters which may be used to support sidelink communications used for U2X services. In this regard, techniques described herein support signaling between UEs 115 and the network which enables the network to register and update subscription data for the UEs 115 associated with U2X services, thereby enabling efficient and widespread use of U2X services.

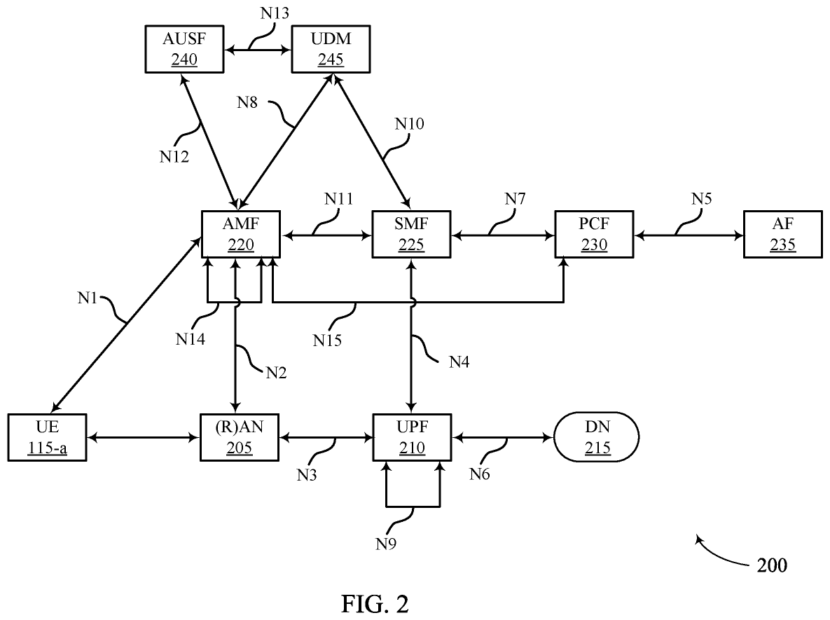

FIG. 2 illustrates an example of a wireless communications system 200 that supports techniques for provisioning U2X parameters in accordance with one or more aspects of the present disclosure. In some examples, wireless communications system 200 may implement, or be implemented by, aspects of wireless communications system 100. In particular, wireless communications system 200 illustrates a 5G system architecture for network access in a non-roaming context.

The wireless communications system 200 may include a UE 115-a, a radio access network (RAN) 205, a user plane function (UPF) 210, a data network (DN) 215, an access and mobility management function (AMF) 220, a session management function (SMF) 225, a policy management function (PCF) 230, an application function (AF) 235, an authentication server function (AUSF) 240, and a unified data management (UDM) 245. Each of the respective components of the wireless communications system 200 may be communicatively coupled to one another via one or more communication links or interfaces. For example, as shown in FIG. 2, the UE 115-a may be communicatively coupled to the AMF 220 via an N1 interface. Similarly, the AMF 220 may be communicatively coupled to the UDM 245 via an N8 interface.

Each of the respective components of the wireless communications system 200 may serve different functions or purposes. In some aspects the RAN 205 may be an example of a network entity 105 such as one or more components of a base station. In this regard, the RAN 205 may include a radio unit (RU), a distributed unit (DU), a central unit (CU), or any combination thereof, where the respective components of the RAN 205 may be co-located, disaggregated, etc. The UPF 210 may be responsible for data packet and forwarding, and may include a function that connects data over the RAN 205 to the internet. The DN 215 may identify service provider services, internet access, and third party services. The AMF 220 is a control plane function which is configured to receive connection and session-related information from the UE 115-a (e.g., via N1 and/or N2 interfaces), and handle connection and mobility management tasks. The SMF 225 is a control plane function configured to update and remove protocol data unit (PDU) sessions, and manage session context with a user plane function (UPF). The PCF 230 manages policies within the wireless communications system 200, and enables operators to efficiently create and deploy policies within the network.

The AF 235 supports application traffic routing, and performs operations such as accessing network exposure function for retrieving resources, interacting with the PCF 230 for policy control, exposing services to end users, and the like. The AUSF 240 performs authentication functions with UEs 115 (E.g., UE 115-a) within the wireless communications system 200. Lastly, the UDM 245 may include a repository to store and control user data within the wireless communications system 200. For example, the UDM 245 may store subscription information associated with UEs 115 (e.g., UE 115-a) within the wireless communications system 200.

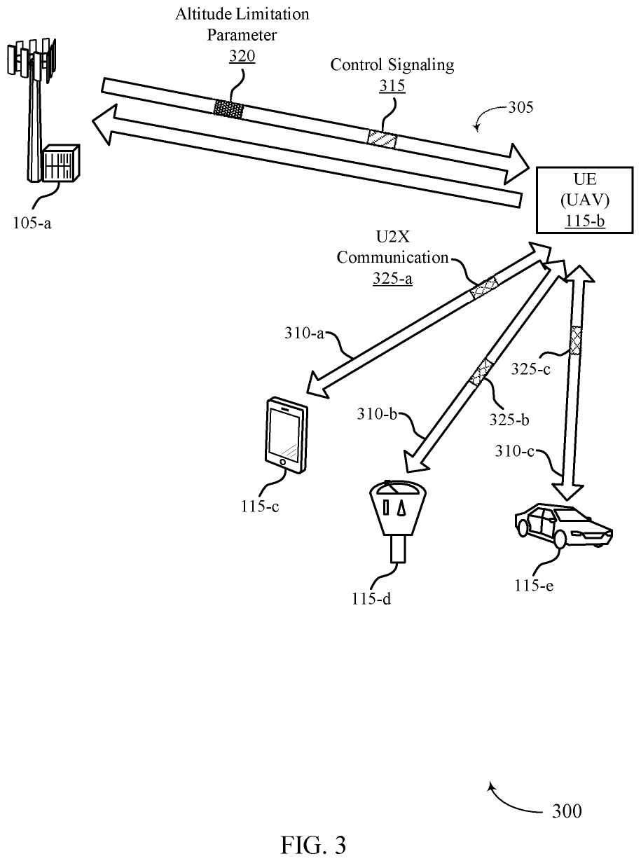

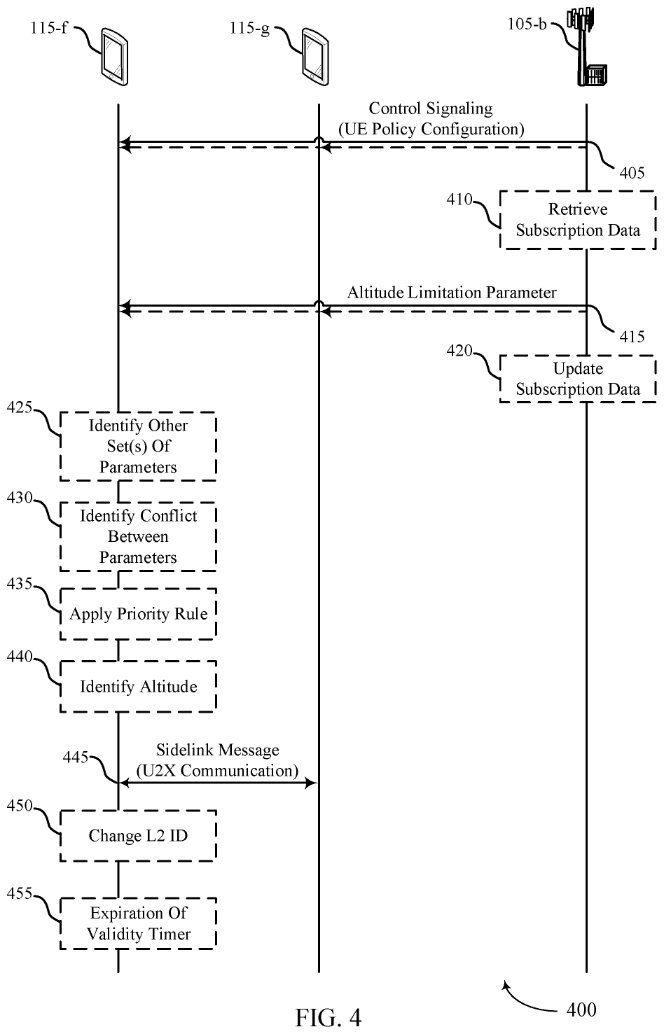

Respective components of the wireless communications system 200 may support registration procedures between the UE 115-a and the network (e.g., various components of the network illustrated in FIG. 2) which enable the UE 115-a to be configured with U2X parameters for U2X services. Signaling between the UE 115-a and the respective components of the wireless communications system 200 used to perform U2X registration procedures may be further shown and described with reference to FIGS. 3 and 4.

FIG. 3 illustrates an example of a wireless communications system 300 that supports techniques for provisioning U2X parameters in accordance with one or more aspects of the present disclosure. In some examples, wireless communications system 200 may implement, or be implemented by, aspects of wireless communications system 100, wireless communications system 200, or both. In particular, wireless communications system 300 may support signaling used to perform U2X registration procedures and U2X registration update procedures between a UE 115-b and the network. In this regard, the wireless communications system 300 may support signaling and configurations which enable the UE 115-b to indicate a capability to perform U2X services, receive parameters and policy configurations for U2X services, and perform sidelink communications for U2X services.

The wireless communications system 300 may include a network entity 105-a (e.g., one or more components of a base station), a first UE 115-b, a second UE 115-c, a third UE 115-d, and a fourth UE 115-e, which may be examples network entities 105, UEs 115, and other wireless as described with reference to FIG. 1. For example, as shown in FIG. 3, the first UE 115-b may include an example of a UAV, where the third UE 115-d and the fourth UE 115-e may include examples of a wireless roadside unit and a vehicle, respectively.

The first UE 115-b may communicate with the network entity 105-a using a communication link 305, which may be an example of an NR or LTE link between the first UE 115-b and the network entity 105-a. In some cases, the communication link 305 between the first UE 115-b and the network entity 105-a may include an example of an access link (e.g., Uu link) which may include a bi-directional link that enables both uplink and downlink communication. For example, the first UE 115-b may transmit uplink signals, such as uplink control signals or uplink data signals (e.g., SRSs), to the network entity 105-a using the communication link 305, and the network entity 105-a may transmit downlink signals, such as downlink control signals or downlink data signals, to the first UE 115-b using the communication link 305. Additionally, or alternatively, the second UE 115-c, the third UE 115-d, the fourth UE 115-e, or any combination thereof, may include communication links (e.g., Uu links) to facilitate wireless communications between the network entity 105-a and the respective UEs 115-c, 115-d, 115-e. Moreover, in some aspects, the first UE 115-a may communicate with the second UE 115-c, the third UE 115-d, and the fourth UE 115-e via a communication links 310-a, 310-b, and 310-c. The communication links 310 between the respective UEs 115 may include examples of sidelink communication links or PC5 links.

As noted previously herein, some wireless communications systems may be configured to support V2X) communications, in which vehicles (e.g., UEs) in a system can communicate with other wireless devices, including roadside infrastructure such as roadside units. For example, in some implementations, the first UE 115-b of the wireless communications system 300 may support V2X communications.

A V2X application may include any application using one or more V2X services, such as an active safety application in a vehicle, using V2X services such as emergency warning and vehicle to vehicle safety and awareness. A V2X application may operate towards a V2X Application Server. In general, the term “V2X communication” may refer to a communication to support V2X services leveraging Uu and/or PC5 reference points. V2X services are realized by various types of V2X applications, including Vehicle-to-Vehicle (V2V), Vehicle-to-Pedestrian (V2P), Vehicle-to-Infrastructure (V2I) and Vehicle-to-Network (V2N). The term “V2X message” refers to a dedicated messaging type of V2X service, for example ITS messages. Moreover, V2X service may include a data service offered to V2X applications and optionally V2X Application Servers. A V2X service belongs to one V2X service type, and may include a message or other data delivery. A V2X service can be associated with one or more V2X applications, and a V2X application can be associated with one or more V2X services. V2X service types may be identified by an ITS application identifier (ITS-AID), a provider service identifier (PSID), an application identifier (AID), or any combination thereof.

Some wireless communications systems may also include UAVs which support UAV services. For example, as shown in FIG. 3, the first UE 115-b may include an example of a UAV in some cases. U2X communications may include sidelink communications (e.g., communications between the UEs 115) to support U2X services by leveraging Uu and/or PC5 reference points. U2X services are realized by various types of U2X applications, including UAV-to-UAV (U2U), UAV-to-Pilot (U2P), UAV-to-Infrastructure (U2I), and UAV-to-Network (U2N). As it is used herein, the term U2X message may refer to a dedicated messaging type of U2X service (e.g., BRID messages). Moreover, the term “U2X service” may refer to a data service offered to U2X applications and optionally U2X Application Servers. A U2X service belongs to one U2X service type. It may include message or other data delivery. A U2X service can be associated with one or more U2X applications, and a U2X application can be associated with one or more U2X services. One example of a U2X service may include “detect and avoid (DAA),” in which a UE 115 may surveil traffic and remain a safe distance from nearby aircraft (e.g., cooperative aircraft and non-cooperative aircraft) so as not to create a collision hazard.

In order to support PC5 based U2X communication, the UEs 115 may be configured with policy and parameters (e.g., RAT type, RF parameters, QoS requirement, Serving PLMN) to perform PC5 communication with other devices. That is, the first UE 115-b may be configured with U2X policy and parameters in order to support sidelink communications with the UEs 115-c, 115-d, 115-d for U2X services. However, parameters and subscription information for V2X does not apply to U2X services due to the different requirements of the service types, applications, policy and QoS requirements, and radio parameters. As such, parameters for V2X communications services do not apply to U2X services. In this regard, conventional V2X techniques may not be suitable for providing U2X policy and parameters to UEs 115. Moreover, based on conventional V2X techniques, it is unclear what policy and parameters may be provided to UEs 115 to support U2X communications, and how UEs 115 are to use received policy and parameters to perform U2X communications.

Accordingly, the respective devices of the wireless communications system 300 may support signaling which enables parameters for U2X services to be indicated and configured at UEs 115 and UAVs (e.g., first UE 115-b). In particular, aspects of the present disclosure support configurations and signaling used to configure the first UE 115-b with U2X parameters, rules for which U2X parameters are provided to the first UE 115-b, and techniques for using U2X parameters at the first UE 115-b. In this regard, aspects of the present disclosure are directed to techniques for registration procedures between the first UE 115-b (e.g., UAVs) and the network (e.g., network entity 105-a) which are used to configure and/or update U2X parameters at the UE 115-a. Moreover, aspects of the present disclosure are directed to rules and priorities for applying U2X parameters in cases where the first UE 115-b is, or is not, configured with a SIM card.

Techniques described herein may leverage, adapt, and re-use other communications mechanisms by adapting architectural and functional modifications in order to support transport Broadcast Remote Identification and C2 communications via the wireless communications system 300. In particular, techniques described herein are directed to architectural and functional modifications to communications mechanisms in order to support aviation applications such as DAA, swarming, etc. Similar to V2X techniques, aspects of the present disclosure are directed to the use of both PC5 and Uu interfaces to support U2X communication (e.g., BRID and DAA).

In the context of U2X communication over the PC5 interface (e.g., communication links 310-a, 310-b, 310-c), two types of PC5 reference points exist: (1) LTE-based PC5 reference point, and (2) NR-based PC5 reference point. In some aspects, the first UE 115-b may use either type of PC5 reference point (e.g., LTE-based, NR-based, or both) for U2X communication depending on the services the first UE 115-b supports. In some implementations, U2X communication over PC5 reference point supports roaming and inter-PLMN operations.

Moreover, as will be described herein, U2X communication may be supported over a PC5 reference point in cases where the respective UE 115 is served by NR or E-UTRA, as well as in cases the respective UE 115 is not served by NR or E-UTRA. In other words, the first UE 115-b may be configured to support U2X communications (e.g., sidelink communications for U2X services) both in cases where the first UE 115-b is communicatively coupled to the network (e.g., network entity 105-a), such as when the first UE 115-b includes a SIM card, as well as in cases where the first UE 115-b is not communicatively coupled to the network, such as when the first UE 115-b does not include a SIM card.

Comparatively, in the context of U2X communication over Uu (e.g., communication link 305), U2X communication via unicast over the Uu reference point supports non-roaming and roaming operations. For transport of U2X messages over Uu reference point, communications mechanisms can be used to establish the suitable PDU Sessions, and U2X messages may be routed towards U2X application server or towards UEs 115 (e.g., UEs 115-c, 115-d, 115-e) with existing unicast routing.

Aspects of the present disclosure are directed to policy parameters for U2X communications, including an altitude limitation parameter or condition for U2X communications (e.g., PC5 communication) in cases where the first UE 115-b is not served by E-UTRA and/or not served by NR (e.g., in cases where the first UE 115-b is not connected to a serving network. Moreover, aspects of the present disclosure are directed to U2X radio parameters for U2X communications for UAVs/UEs 115 with and without a Universal Integrated Circuit Card (UICC) (e.g., UAVs/UEs 115 with and without a SIM card). In particular, some aspects of the present disclosure are directed to a set of new policy information in UE policy for U2X communications (e.g., U2X Policy (U2XP)).

For example, as shown in FIG. 3, the first UE 115-b may receive control signaling 315 indicating a UE policy configuration including a set of radio parameters usable by the first UE 115-b to perform sidelink communications to support one or more UAV services (e.g., U2X communications 325). In other words, the first UE 115-b may receive control signaling 315 for a U2X policy configuration associated with U2X communications 325. The control signaling 315 may include, but is not limited to, RRC signaling, SIB signaling, and the like.

In some aspects, the UE policy (e.g., UE policy configuration) may be configured in a PCF (e.g., PCF 230 illustrated in FIG. 2) and delivered to the first UE 115-b. The U2X policy configuration may be exposed to U2X application server for configuration updating request. The UE policy configuration may include, but is not limited to, Access Network Discovery and Selection Policy (ANDSP) information, UE Route Selection Policy (URSP) information, V2X Policy (V2XP) information, U2X Policy (U2XP) information, ProSe Policy (ProSeP) information, or any combination thereof.

ANDSP may be used by the first UE 115-b for selecting non-3GPP accesses networks, where URSP may be used by the first UE 115-b to determine how to route outgoing traffic. Traffic can be routed to an established PDU Session, offloaded to non-3GPP access outside a PDU session, routed via a ProSe Layer-3 UE-to-Network Relay outside a PDU session, trigger the establishment of a new PDU session, or any combination thereof. V2XP may provide configuration parameters to the first UE 115-b for V2X communication over PC5 reference point, over Uu reference point, or both. U2XP may provide configuration parameters to the first UE 115-b for U2X communications 325 over PC5 reference point, over Uu reference point, or both. Finally, ProSeP may provide configuration parameters to the first UE 115-b for ProSe Direct Discovery, ProSe Direct Communication, ProSe UE-to-Network Relay and Remote UE.

The set of radio parameters of the UE policy configuration indicated via the control signaling 315 may include any radio parameters associated with the performance of U2X communications 325, including applicable frequency ranges (e.g., BWPs), geographical areas, altitude ranges, modes of communication (e.g., unicast, groupcast, multicast), L2 identifiers, a sidelink QoS metrics, radio bearers, DRX cycles, or any combination thereof. As will be described in more detail herein, different sets of UAV services supported at the first UE 115-b may be associated with different sets (or subsets) of radio parameters.

As will be described herein, the first UE 115-f may receive (or be configured with) radio parameters for U2X communications via a variety of sources. For example, parameters for U2X communications over PC5 and Uu reference points may be made available to the first UE 115-a in following ways: (1) pre-configured in the ME, (2) configured in the UICC (e.g., SIM card), (3) preconfigured at the UE 115 and configured in the UICC, (4) provided/updated by the U2X application server to the first UE 115-b, (5) provided/updated by the PCF (e.g., PCF 230 in FIG. 2) to the first UE 115-b, or any combination thereof. Radio parameters may be prioritized differently depending on the source from which the respective radio parameters are configured, as will be described in further detail herein.

For UAVs without UICC (e.g., UAVs without a SIM card, UAVs with no subscription to the mobile network), the U2X communications parameters from U2X application server or PCF may be delivered via a UAV controller (UAV-C) UE. In particular, UAVs without UICC may only perform PC5 communication over PC5 when authorized for wireless communications and/or U2X communications in cases where the respective UAVs are not connected to a serving network (e.g., not served by E-UTRA and not served by NR). For example, in cases where the first UE 115-b does not have a connection to the network entity 105-a, the first UE 115-b may receive the UE policy configuration and radio parameters for U2X communications via another UE 115, such as the second UE 115-c. In such cases, the second UE 115-c may serve as a UAV controller, where the second UE 115-c forwards, or relays, information from the network entity 105-a to the first UE 115-b.

Some aspects of the present disclosure may support information for non-session management related network capability exposure. Support for network capability exposure enables an AF, such as the AF 235 in FIG. 2 (e.g., an external ASP) to request the non-session management related policy control functionality from the NEF. Information which may be requested by the AF may include, but is not limited to, information associated with the management of PFDs, information associated with negotiations for future background data transfer as defined, information associated with applying a previously negotiated background data transfer policy to a UE 115 or group of UEs 115, information associated with traffic steering control for AF-influenced traffic diversion, information associated with service-specific parameter provisioning for V2X communication, information associated with service specific parameter provisioning for U2X communications, information associated with 5G VN group management, information associated with service-specific parameter provisioning for ProSe Direct Discovery, ProSe Direct Communication, ProSe Relay Discovery and ProSe Relay Communications, information associated with service specific parameter provisioning for time synchronization service, or any combination thereof.

In some aspects, the network entity 105-a may retrieve subscription data associated with the first UE 115-b. The subscription data may include information associated with a capability and authorization of the first UE 115-b to perform U2X communications 325. The network entity 105-a may retrieve subscription data (e.g., U2X subscription data) based on transmitting the control signaling 315. For example, as described previously herein, the network entity 105-a may retrieve subscription data associated with the first UE 115-b via a UDM, such as the UDM 245 illustrated in FIG. 2.

In some aspects, the first UE 115-b may receive, from the network entity 105-a, an altitude limitation parameter 320 associated with the one or more UAV services. The first UE 115-b may receive the altitude limitation parameter 320 via the control signaling 315, additional: control signaling, or both. The altitude limitation parameter 320 may be associated with UAV services (e.g., U2X communications 325) that may be performed by the first UE 115-b. For example, the altitude limitation parameter 320 may include an altitude range associated with an authorization for the one or more UAV services. In such cases, the first UE 115-b may be configured/authorized to perform UAV services only in cases where the first UE 115-b is at an altitude within the altitude range associated with the altitude limitation parameter 320. In other words, the first UE 115-b may satisfy the altitude limitation parameter 320 when it is at an altitude that is within the defined altitude range.

In some cases, the first UE 115-b may receive the altitude limitation parameter 320 from the network entity 105-a via a Uu interface with the network entity 105-a, as shown in FIG. 3. Additionally, or alternatively, the first UE 115-b may receive the altitude limitation parameter 320 via the second UE 115-c. For instance, in cases where the first UE 115-b is not connected to the network (e.g., cases where the first UE 115-b does not include a SIM card), the first UE 115-b may receive control signaling 315 indicating the altitude limitation parameter 320 from the second UE 115-c. In such cases, the second UE 115-c may forward, or relay, the control signaling 315 from the network entity 105-a to the first UE 115-b.

The control signaling 315 (and/or additional control signaling) may provide provisioning for U2X communications 325, such as U2X communications over PC5 reference point. Information associated with U2X communications 315 which may be configured, indicated, or provisioned at the first UE 115-b may include, but is not limited to: (1) authorization policy information, (2) radio parameters for when the first UE 115-b is/is not connected to a serving network, (3) policy/parameters for PC5 RAT selection and PC5 Tx profile selection, (4) policy/parameters related to privacy, (5) policy/parameters for when LTE PC5 is selected, (6) policy/parameters for when NRPC5 is selected, (7) validity timer(s) indicating expiration times of U2X policy and/or U2X parameters, or any combination thereof. Such information/parameters may be configured at the first UE 115-b by the U2X application server (which may be controlled/accessed by the network entity 105-a). Each of these respective parameters/information will be described in further detail herein.

Authorization policy information may indicate whether the first UE 115-b is authorized to perform UAV services (e.g., U2X communications 325) when the first UE 115-a is served by E-UTRA or NR. That is, authorization policy information may indicate whether the first UE 115-a is authorized to perform U2X communications in cases where the first UE 115-b is connected to a serving network. In such cases, authorization policy information may indicate PLMNs in which the first UE 115-a is authorized to perform U2X communications 325 over PC5 reference point when the first UE 115-b is connected to a serving network. For each PLMN, the authorization policy information may indicate one or more RATs over which the first UE 115-a is authorized to perform U2X communications 325 over PC5 reference point.

Additionally, or alternatively, authorization policy information may indicate whether the first UE 115-b is authorized to perform UAV services (e.g., U2X communications 325) when the first UE 115-a is not served by E-UTRA or NR. That is, authorization policy information may indicate whether the first UE 115-a is authorized to perform U2X communications in cases where the first UE 115-b is not connected to a serving network. In such cases, the authorization policy information may indicate whether the first UE 115-b is authorized to perform U2X communications 325 over PC5 reference point when the first UE 115-b is not served by E-UTRA or by NR, and one or more RATs over which the first UE 115-b is authorized to perform U2X communications 325 when not connected to a serving network.

Radio parameters indicated via the control signaling 315 and/or additional control signaling may include radio parameters used for U2X communications when the first UE 115-b is not served by E-UTRA or by NR (e.g., radio parameters for U2X communications 325 when the first UE 115-b is not connected to a serving network). This may include radio parameters per PC5 RAT (e.g., LTE PC5, NR PC5) with geographical area(s), altitude limitation (e.g., altitude limitation parameter), frequency bands, and an indication of whether the respective radio parameters are “operator managed” or “non-operator managed.” Whether a frequency band is “operator managed” or “non-operator managed” in a given geographical area may be defined by local regulations.

In some aspects, the first UE 115-b may use the configured radio parameters to perform U2X communications 325 over PC5 reference point when the first UE 115-b is not connected to a serving network (e.g., not served by E-UTRA, and not served by NR) in cases where the first UE 115-b can reliably locate itself in the corresponding geographical area and altitude limitation. Otherwise, the first UE 115-b is not authorized to transmit. In other words, the first UE 115-b may be configured to determine that it is not authorized to perform U2X communications in cases where the first UE 115-b is unable to reliably confirm it satisfies applicable geographical areas and/or the altitude limitation parameter 320.

The control signaling 315 (and/or additional control signaling) may indicate policy/parameters for PC5 RAT selection and for PC5 Tx Profile selection. Such information may indicate a mapping(s) of U2X service types to PC5 RAT(s) (e.g., LTE PC5, NR PC5, or both), and mapping(s) for LTE PC5 to the corresponding Tx Profiles. Additionally, or alternatively, the control signaling 315 and/or additional control signaling may indicate policy/parameters related to privacy. For example, the control signaling 315 may indicate privacy parameters that enable the first UE 115-b to periodically or intermittently change an L2 identifier associated with the first UE 115-b, the UE policy configuration, the UAV services, or any combination thereof. For example, the control signaling 325 may indicate a privacy timer value indicating a time interval or duration after which the first UE 115-b may change the L2 identifier self-assigned by the first UE 115-b when privacy is desired or required. The control signaling 315 may indicate a list of U2X service types (e.g., list of UAV services) with geographical areas that require privacy support.

In some aspects, the control signaling 315 may indicate policy/parameters for when specific RATs are selected for U2X communications (e.g., when LTE PC5 is selected, when NR PC5). In cases where LTE PC5 is selected for U2X communications, the control signaling 315 (and/or additional control signaling) may indicate policy/parameters except for the mapping of U2X service types to Tx profiles and the list of U2X services with geographical area(s) that require privacy support.

Comparatively, in cases where NR PC5 is selected for U2X communications, the control signaling 315 (and/or additional control signaling) may indicate any number of parameters associated with the UE policy configuration, supported UAV services (e.g., U2X communications), etc. In particular, the control signaling 315 may indicate various mappings between radio parameters and corresponding UAV services. In other words, each supported UAV service may be associated with a different set or subset of radio parameters, and the control signaling 315 may indicate the mappings between the UAV services and the respective parameters.

Mappings indicated via the control signaling 315 may include, but are not limited to, mappings of U2X service types (e.g., UAV services) to U2X frequencies with geographical area(s) and altitude limitation(s) (e.g., altitude limitation parameter 320), mappings of U2X service types to the default mode of communication (e.g., broadcast mode, groupcast mode, unicast mode), mappings of U2X service types to destination L2 identifier(s) for broadcast and/or groupcast communication modes, mappings of U2X service types to default destination L2 identifiers(s) for initial signaling to establish unicast connection, mappings of U2X service types to PC5 QoS parameters (e.g., PQI and conditionally other parameters such as maximum flow bit rate (MFBR) and/or guaranteed flow bit rate (GFBR), etc.). Additionally, or alternatively, the control signaling 315 (and/or additional control signaling) may indicate AS layer configurations (e.g., the mapping of PC5 QoS profile(s) to radio bearer(s), when the first UE 115-b is not connected to a serving network). In such cases, the PC5 QoS profile may include PC5 QoS parameters, and value(s) for the QoS characteristics associated with priority level, averaging window, maximum data burst volume if a default value is not used as a defined default value, or any combination thereof. For broadcast and groupcast (e.g., UAV services performed via broadcast and/or groupcast), the control signaling 315 may indicate a PC5 DRX configuration when the first UE 115-b is not connected to a serving cell (e.g., not served by E-UTRA and not served by NR), including a mapping of PC5 QoS profiles to PC5 DRX cycle configuration(s).

In some implementations, the first UE 115-b may identify one or more additional radio parameters associated with a performance of UAV services. In particular, the first UE 115-b may identify one or more additional radio parameters which were indicated/configured via a source other than the network entity 105-a. For example, in some cases, the first UE 115-b may identify an additional set of radio parameters associated with UAV services based on a SIM card associated with the first UE 115-b. In this regard, the first UE 115-b may receive a first set of radio parameters for UAV services via the control signaling 315, and a second set of radio parameters for UAV services via a SIM card.

In some aspects, the first UE 115-b may identify a conflict between one or more radio parameters. In particular, the first UE 115-b may identify a conflict between radio parameters which were configured via different sources. In this regard, the first UE 115-b may identify the conflict based on receiving the control signaling 315 (and/or additional control signaling), receiving the altitude limitation parameter 320, identifying one or more additional radio parameters configured via another source, or any combination thereof.

For example, continuing with the example above, the first UE 115-b may receive a first set of radio parameters for UAV services via the control signaling 315, and a second set of radio parameters for UAV services via a SIM card. In this example, the first UE 115-b may identify a conflict between a first radio parameter within the first set of radio parameters and a second radio parameter within the second set of radio parameters. For instance, the control signaling 315 may indicate that the first UE 115-b is authorized to perform a UAV service within a given BWP, but the SIM card may indicate that the first UE 115-b is not authorized to perform the UAV service within the BWP.

Upon identifying a conflict between radio parameters, the first UE 115-b may identify and apply a priority rule to resolve the identified conflict. Priority rules may resolve conflicts between conflicting radio parameters configured via different sources. As such, the first UE 115-b may apply one or more priority rules to resolve conflicts between radio parameters in order to determine which radio parameters will be used to perform UAV services/U2X communications 325.

For example, in cases where the control signaling 315 (and/or additional control signaling 315) indicates one or more priority rules, the first UE 115-b may resolve the identified conflict by applying one of the configured priority rules. For instance, the priority rules may prioritize radio parameters provided by a PCF over radio parameters provided by an application server (e.g., U2X application server). Similarly, the priority rules may prioritize radio parameters provided by the application server over radio parameters provided by a SIM card (e.g., UICC), and may prioritize radio parameters provided by the SIM card over radio parameters configured (e.g., pre-configured) at the first UE 115-b. As such, in this example, the first UE 115-b may prioritize (e.g., utilize, implement) a radio parameter configured via the control signaling 315 over a conflicting radio parameter configured via a SIM card.

For U2X communication over PC5 reference point, the operator may configure the first UE 115-b with the required provisioning parameters for U2X communication, without the need for the first UE 115-b to connect to the network to receive the initial configuration. In such cases, the provisioning parameters for U2X communications over PC5 reference point may be configured in the UICC (e.g., SIM card), configured at the UE 115-b, or in both the UICC and the UE 115-b. In some cases, the UE 115-b provisioning parameters may not be erased when a USIM is deselected or replaced. As described herein with respect to the priority rules, if both the UICC and the UE 115-b contain the same set of overlapping provisioning parameters, the set of parameters from the UICC may take precedence. Moreover, the provisioning parameters from the PCF or U2X application server may take precedence over the pre-configured parameters in the UE 115-b and UICC. The UE provisioning may support setting geographical areas and altitude limitation (e.g., altitude limitation parameter 320), where the U2X communications 325 over PC5 reference point may be specified for E-UTRA and NR.

In some aspects, the first UE 115-b may identify an altitude associated with the first UE 115-b. The first UE 115-b may identify its altitude at based on receiving the control signaling 315, receiving the altitude limitation parameter 320, identifying other radio parameters, identifying a conflict between radio parameters, applying a priority rule(s), or any combination thereof.

For example, the first UE 115-b may determine whether the current altitude of the first UE 115-b satisfies the altitude limitation parameter 320 in order to determine whether the first UE 115-b is authorized to perform UAV services (e.g., U2X communications 325). As noted previously herein, in some cases, the altitude limitation parameter 320 may include an altitude range associated with an authorization for the one or more UAV services, where the identified altitude satisfies the altitude limitation parameter 320 if the identified altitude is within the altitude range (e.g., first UE 115-b is only authorized to perform UAV services within defined altitude ranges). In some aspects, different UAV services may be associated with different altitude limitation parameters 320.

In some implementations, the first UE 115-b may communicate (e.g., transmit, receive) a sidelink message associated with the one or more supported/authorized UAV services. For example, the first UE 115-b may perform U2X communications 325-a, 325-b, 325-c with the respective UEs 115-c, 115-d, 115-e. In particular, the first UE 115-b may communicate the sidelink message (e.g., perform a U2X communication 325) for the UAV service in accordance with the UE policy configuration and the altitude limitation parameter 320. In other words, the first UE 115-b may perform U2X communications 325 in accordance with the radio parameters associated with the UE policy configuration and UAV service, and based on a satisfaction of the altitude limitation parameter 320.

When performing U2X communications 325 over PC5 reference point, and while the UE 115-b has a serving cell and is camped on a cell (e.g., serving cell supported by network entity 105-a) the UE 115-b intends to use for U2X service for the radio resources (e.g., carrier frequency) operated by the respective cell, the UE 115-b may be configured to use the radio resource description indicated by the serving cell the UE 115-b is camped on and ignore any radio resource description of the same radio resource provisioned at the UE 115-b or the UICC. If the cell does not provide radio resources for U2X service, the UE 115-b may not perform U2X message transmission and reception (e.g., transmit/receive U2X communications 325) on radio resources operated by the cell.

If the UE 115-b intends to use “operator-managed” radio resources/parameters (e.g., carrier frequency) for U2X service that are not operated by the UE's serving cell, or if the UE 115-b is out of coverage, the UE 115-b may be configured to search for a cell in any PLMN that is operating the provisioned radio resources (e.g., carrier frequency). In the UE 115-b finds such a cell in the registered PLMN or a PLMN equivalent to the registered PLMN, and authorization for U2X communications 325 over PC5 reference point to this PLMN is confirmed, the UE 115-b may use the radio resource description indicated by that cell. If that cell does not provide radio resources for U2X service, the UE 115-b may not perform U2X message transmission and reception (e.g., perform U2X communications 325) on those radio resources.

Comparatively, if the UE 115-b finds such a cell but not in the registered PLMN or a PLMN equivalent to the registered PLMN, and that cell belongs to a PLMN authorized for U2X communications 325 over PC5 reference point and provides radio resources for U2X service, then the UE 115-b may perform PLMN selection triggered by U2X communications 325 over PC5 reference point. If the UE 115-b has an ongoing emergency session via IMS, it may not trigger any PLMN selection due to U2X communication 325 over PC5 reference point. Moreover, if the UE 115-b finds such a cell but not in a PLMN authorized for U2X communications 325 over PC5 reference point, the UE 115-b may not perform U2X communications 325 over PC5 reference point. Further, if the UE 115-b does not find any such cell in any PLMN, then the UE 115-b may consider itself out of network connection (e.g., not served by NR or E-UTRA), and may use radio resources provisioned in the UE 115-b or the UICC (e.g., SIM card). If no such provision exists in at the UE 115-b or the UICC, or the provision does not authorize U2X communications 325 over PC5 reference point, then the UE 115-b is not authorized to transmit the U2X communications 325.

If the UE intends to use “non-operator-managed” radio resources/parameters (e.g., carrier frequency) to perform the U2X communications 325, the UE 115-b may perform the U2X communication 325 over PC5 using resource provisioned in the UE 115-b or the UICC (SIM card). If no such provision exists at the UE 115-b or the UICC, or the provision does not authorize U2X communications 325 over PC5 reference point, then the UE 115-b is not authorized to transmit the U2X communications 325.

In some aspects, the first UE 115-b may change an L2 identifier for sidelink communications (e.g., L2 identifier associated with U2X communications 325). As noted previously herein, the first UE 115-b may periodically change an L2 identifier for sidelink communications (e.g., to avoid being traced). For instance, the first UE 115-b may receive a privacy timer value via the control signaling 315, and may change the L2 identifier in accordance with the privacy timer value (e.g., based on an expiration of the privacy timer value).

In some aspects, the first UE 115-b may identify an expiration of a validity timer associated with the UE policy configuration, UAV services, or both. The validity timer(s) may be configured via the control signaling 315, via additional control signaling, or both. The expiration of the validity timer may indicate that the UE policy configuration is no longer valid, or that the first UE 115-b is no longer authorized to perform the respective UAV services. As such, the first UE 115-b may refrain from performing UAV services/U2X communications 325 following the expiration of the validity timer.

Techniques described herein may enable registration procedures between UEs 115 (e.g., UAVs) and the network which are used to configure U2X parameters at the UEs 115, in particular, techniques described herein enable UEs 115 to be efficiently configured with U2X parameters which may be used to support sidelink communications used for U2X services. In this regard, techniques described herein support signaling between UEs 115 and the network which enables the network to register and update subscription data for the UEs 115 associated with U2X services, thereby enabling efficient and widespread use of U2X services.

FIG. 4 illustrates an example of a process flow 400 that supports techniques for provisioning U2X parameters in accordance with one or more aspects of the present disclosure. In some examples, process flow 400 may implement, or be implemented by, aspects of wireless communications system 100, wireless communications system 200, wireless communications system 300, or any combination thereof. For example, the process flow 400 illustrates a first UE 115-f receiving a UE policy configuration for UAV services (e.g., U2X policy configuration), receiving an altitude limitation parameter associated with U2X services, and performing U2X services in accordance with the UE policy configuration and altitude limitation parameter, as described with reference to FIGS. 1-3.

In some cases, process flow 400 may include a first UE 115-f, a second UE 115-g, and a network entity 105-b (e.g., base station), which may be examples of corresponding devices as described herein. In particular, the first UE 115-f and the second UE 115-g illustrated in FIG. 4 may include examples of the first UE 115-b and the second UE 115-c, respectively, as illustrated in FIG. 2. In some aspects, the first UE 115-f may include a UE 115, UAV, or both, that is configured to perform U2X communications. Similarly, the network entity 105-b illustrated in FIG. 4 may include an example of the network entity 105-a illustrated in FIG. 2.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 405, the first UE 115-f may receive control signaling indicating a UE policy configuration including a set of radio parameters usable by the first UE 115-f to perform sidelink communications to support one or more UAV services (e.g., U2X services). In other words, the first UE 115-f may receive control signaling for a U2X policy configuration associated with U2X communications. The control signaling may include, but is not limited to, RRC signaling, SIB signaling, and the like.

The set of radio parameters of the UE policy configuration may include any radio parameters associated with the performance of U2X communications, including applicable frequency ranges (e.g., BWPs), geographical areas, altitude ranges, modes of communication (e.g., unicast, groupcast, multicast), L2 identifiers, a sidelink Qos metrics, radio bearers, DRX cycles, or any combination thereof. As will be described in more detail herein, different sets of UAV services supported at the first UE 115-f may be associated with different sets (or subsets) of radio parameters.

In some cases, the first UE 115-f may receive the control signaling from the network entity 105-b via a Uu interface with the network entity 105-b, as shown in FIG. 2. Additionally, or alternatively, the first UE 115-f may receive the control signaling via the second UE 115-g. For instance, in cases where the first UE 115-f is not connected to the network (e.g., cases where the first UE 115-f does not include a SIM card), the first UE 115-f may receive control signaling indicating the UE policy control configuration from the second UE 115-g. In such cases, the second UE 115-g may forward, or relay, the control signaling from the network entity 105-b to the first UE 115-f.

At 410, the network entity 105-b may retrieve subscription data associated with the first UE 115-f. The subscription data may include information associated with a capability and authorization of the first UE 115-f to perform U2X communications. The network entity 105-b may retrieve subscription data (e.g., U2X subscription data) based on transmitting the control signaling at 405. For example, as described previously herein, the network entity 105-b may retrieve subscription data associated with the first UE 115-f via a UDM, such as the UDM 245 illustrated in FIG. 2.

At 415, the first UE 115-f may receive, from the network entity 105-b, an altitude limitation parameter associated with the one or more UAV services. The first UE 115-f may receive the altitude limitation parameter via the control signaling at 405, additional: control signaling, or both. As such, while the altitude limitation parameter is shown in FIG. 4 as being communicated separately from the control signaling, the altitude limitation parameter may be communicated via the control signaling at 405 in some implementations. As such, the first UE 115-f may receive, and the network entity 105-b may transmit, the indication of the altitude limitation parameter at 415 based on receiving/transmitting the control signaling at 405, receiving/transmitting additional control signaling, retrieving the subscription data at 410, or any combination thereof.

The altitude limitation parameter may be associated with UAV services (e.g., U2X communications) that may be performed by the first UE 115-f. For example, the altitude limitation parameter may include an altitude range associated with an authorization for the one or more UAV services. In such cases, the first UE 115-f may be configured/authorized to perform UAV services only in cases where the first UE 115-f is at an altitude within the altitude range associated with the altitude limitation parameter. In other words, the first UE 115-f may satisfy the altitude limitation parameter when it is at an altitude that is within the defined altitude range.

In some cases, the first UE 115-f may receive the altitude limitation parameter from the network entity 105-b via a Uu interface with the network entity 105-b, as shown in FIG. 2. Additionally, or alternatively, the first UE 115-f may receive the altitude limitation parameter via the second UE 115-g. For instance, in cases where the first UE 115-f is not connected to the network (e.g., cases where the first UE 115-f does not include a SIM card), the first UE 115-f may receive control signaling indicating the altitude limitation parameter from the second UE 115-g. In such cases, the second UE 115-g may forward, or relay, the control signaling from the network entity 105-b to the first UE 115-f.

The control signaling at 405, additional control signaling, or both, may additionally or alternatively indicate additional parameters, conditions, and characteristics associated with the performance of U2X communications at the first UE 115-f. Other parameters, conditions, and characteristics that may be configured via the control signaling at 405 and/or additional control signaling may include, but are not limited to, priority rules associated with conflicts between radio parameters for U2X communications, RATs associated with the UE policy configuration, RATs associated with the respective UAV services, an authorization to perform UAV services (e.g., authorization to perform U2X communications), an authorization to perform UAV services when the first UE 115-f is (or is not) connected to the network, privacy parameters (e.g., privacy timer value) associated with the UE policy configuration and/or UAV services, a validity timer associated with the UE policy configuration and/or UAV services, mappings between the UAV services and corresponding subsets of ratio parameters (e.g., frequency ranges, geographical areas, altitude ranges, modes of communication, L2 identifiers, sidelink QoS metrics, radio bearers, DRX cycles, etc.), an indication as to whether radio parameters are operator-managed or non-operator managed, or any combination thereof.

For example, the first UE 115-f may receive, via the control signaling at 405, additional control signaling, or both, an indication of one or more priority rules associated with conflicts between the set of radio parameters associated with the UE policy configuration and one or more additional radio parameters. In other words, the first UE 115-f may be configured with a set of priority rules which enable the first UE 115-f to resolve conflicts in cases where radio parameters of the UE policy configuration conflict with radio parameters configured via other sources. Priority rules may resolve conflicts between conflicting radio parameters configured via different sources. For instance, the priority rules may prioritize radio parameters provided by a PCF over radio parameters provided by an application server. Similarly, the priority rules may prioritize radio parameters provided by the application server over radio parameters provided by a SIM card, and may prioritize radio parameters provided by the SIM card over radio parameters configured at the first UE 115-f.

By way of another example, the first UE 115-f may receive, via the control signaling at 405, additional control signaling, or both, an indication of one or more RATs associated with the UE policy configuration. In other words, the network entity 105-b may indicate which RATs the UE policy configuration applies to (e.g., LTE, 4G, NR, 5G). For instance, the control signaling at 405, additional control signaling, or both, may authorization the first UE 115-f to perform UAV services in accordance with the UE policy configuration and the indicated RATs (e.g., authorize the first UE 115-f to perform UAV services via LTE but not NR, or vice versa). Similarly, the control signaling at 405, additional control signaling, or both, may indicate RATs associated with respective UAV services. For example, the control signaling may indicate that a first subset of UAV services may be performed via LTE, and that a second subset of UAV services may be performed via NR.

In some implementations, the control signaling at 405, additional control signaling, or both, may authorize the first UE 115-f to perform UAV services in cases where the first UE 115-f is connected to a serving network, in cases where the first UE 115-f is not connected to a serving network, or both. In other words, the first UE 115-f may be configured/authorized to perform UAV services (e.g., U2X communications) in cases where the first UE 115-f includes a SIM card (and is therefore connected to the network), in cases where the first UE 115-f does not include a SIM card (and is therefore disconnected from the network), or both.

In additional or alternative implementations, the control signaling at 405, additional control signaling, or both, may include an indication of one or more privacy parameters associated with the one or more UAV services, one or more geographical areas associated with the UAV services, or both. Privacy parameters, when configured, may cause the first UE 115-f to periodically change an L2 identifier for sidelink communications (e.g., to avoid being traced). For instance, the first UE 115-f may receive a privacy timer value associated with the UE policy configuration, where the privacy timer value indicates a time interval in which the first UE 115-f is to randomly change an L2 identifier associated with UAV services (e.g., L2 identifier associated with U2X communications). By way of another example, the first UE 115-f may receive an indication of geographical areas in which respective UAV services may be performed (e.g., authorization to perform a first UAV service in a first geographical area, authorization to perform a second UAV service in a second geographical area).

In additional or alternative implementations, the control signaling at 405, additional control signaling, or both, may indicate a validity timer associated with the UE policy configuration, the radio parameters associated with the UAV services, or both. The validity timer may indicate a time interval or duration of time in which the UE policy configuration is valid, or in which the first UE 115-f is authorized to perform respective UAV services. Different UAV services may be associated with different validity timers. In other words, the first UE 115-f may be authorized to perform a first UAV service for a limited duration of time (e.g., based on a validity timer), where the first UE 115-f may be authorized to perform a second UAV service indefinitely (e.g., no validity timer, or indefinite validity timer).

In general, the control signaling at 405, additional control signaling, or both, may indicate mappings between the respective UAV services and specific subsets of radio parameters associated with the UE policy configuration. For example, a first UAV service may be associated with a first set (or first subset) of radio parameters, where a second UAV service may be associated with a first set (or first subset) of radio parameters. As noted previously herein, radio parameters associated with UAV services/U2X communications may include, but are not limited to, applicable frequency ranges (e.g., BWPs), geographical areas, altitude ranges, modes of communication (e.g., unicast, groupcast, multicast), L2 identifiers, a sidelink QoS metrics, radio bearers, DRX cycles, or any combination thereof. Moreover, in some implementations, the control signaling at 405, additional control signaling, or both, may indicate whether the set(s) of radio parameters (or respective subsets of the configured radio parameters) are operator-managed, non-operator-managed, or both.

At 420, the network entity 105-b may update subscription data associated with the first UE 115-f. For example, the network entity 105-b may update subscription data (e.g., U2X subscription data) associated with the UE 115-f stored within a UDM, such as the UDM 245 illustrated in FIG. 2. The network entity 105-b may update the subscription data at 420 based on transmitting the control signaling at 405, retrieving the subscription data at 410, transmitting the altitude limitation parameter at 415, or any combination thereof.

At 425, the first UE 115-f may identify one or more additional radio parameters associated with a performance of UAV services. In particular, the first UE 115-f may identify one or more additional radio parameters which were indicated/configured via a source other than the network entity 105-b. For example, in some cases, the first UE 115-f may identify an additional set of radio parameters associated with UAV services based on a SIM card associated with the first UE 115-f. In this regard, the first UE 115-f may receive a first set of radio parameters for UAV services via the control signaling at 405, and a second set of radio parameters for UAV services via a SIM card.

At 430, the first UE 115-f may identify a conflict between one or more radio parameters. In particular, the first UE 115-f may identify a conflict between radio parameters which were configured via different sources. In this regard, the first UE 115-f may identify the conflict at 430 based on receiving the control signaling at 405, receiving additional control signaling, receiving the altitude limitation parameter at 415, identifying one or more additional radio parameters at 425, or any combination thereof.

For example, continuing with the example above, the first UE 115-f may receive a first set of radio parameters for UAV services via the control signaling at 405, and a second set of radio parameters for UAV services via a SIM card. In this example, the first UE 115-f may identify a conflict between a first radio parameter within the first set of radio parameters and a second radio parameter within the second set of radio parameters. For instance, the control signaling at 405 may indicate that the first UE 115-f is authorized to perform a UAV service within a given BWP, but the SIM card may indicate that the first UE 115-f is not authorized to perform the UAV service within the BWP.

At 435, the first UE 115-f may identify and apply a priority rule to resolve the conflict identified at 430. Priority rules may resolve conflicts between conflicting radio parameters configured via different sources. As such, the first UE 115-f may apply one or more priority rules to resolve conflicts between radio parameters in order to determine which radio parameters will be used to perform UAV services/U2X communications.

For example, in cases where the control signaling at 405 (and/or additional control signaling) indicates one or more priority rules, the first UE 115-f may resolve the identified conflict by applying one of the configured priority rules. For instance, the priority rules may prioritize radio parameters provided by a PCF over radio parameters provided by an application server. Similarly, the priority rules may prioritize radio parameters provided by the application server over radio parameters provided by a SIM card, and may prioritize radio parameters provided by the SIM card over radio parameters configured at the first UE 115-f. As such, in this example, the first UE 115-f may prioritize (e.g., utilize, implement) a radio parameter configured via the control signaling at 405 over a conflicting radio parameter configured via a SIM card at 425.

At 440, the first UE 115-f may identify an altitude associated with the first UE 115-f. The first UE 115-f may identify its altitude at 440 based on receiving the control signaling at 405, receiving the altitude limitation parameter at 415, identifying other radio parameters at 425, identifying the conflict at 430, applying the priority rule(s) at 435, or any combination thereof.

For example, the first UE 115-f may determine whether the current altitude of the first UE 115-f satisfies the altitude limitation parameter in order to determine whether the first UE 115-f is authorized to perform UAV services (e.g., U2X communications). As noted previously herein, in some cases, the altitude limitation parameter may include an altitude range associated with an authorization for the one or more UAV services, where the identified altitude satisfies the altitude limitation parameter if the identified altitude is within the altitude range (e.g., first UE 115-f is only authorized to perform UAV services within defined altitude ranges). In some aspects, different UAV services may be associated with different altitude limitation parameters.

At 445, the first UE 115-f may communicate (e.g., transmit, receive) a sidelink message associated with the one or more supported/authorized UAV services. In particular, the first UE 115-f may communicate the sidelink message (e.g., perform a U2X communication) for the UAV service in accordance with the UE policy configuration and the altitude limitation parameter. In other words, the first UE 115-f may perform a U2X communication at 445 in accordance with the radio parameters associated with the UE policy configuration and UAV service, and based on a satisfaction of the altitude limitation parameter.

As such, the first UE 115-f may communicate the sidelink message (e.g., perform a U2X communication) for a UAV service at 445 based on receiving the control signaling at 405, receiving the altitude limitation parameter at 415, identifying other radio parameters at 425, identifying the conflict at 430, applying the priority rule(s) at 435, identifying the altitude at 440, or any combination thereof.

At 450, the first UE 115-f may change an L2 identifier for sidelink communications (e.g., L2 identifier associated with U2X communications). As noted previously herein, the first UE 115-f may periodically change an L2 identifier for sidelink communications (e.g., to avoid being traced). For instance, the first UE 115-f may receive a privacy timer value via the control signaling at 405, and may change the L2 identifier at 450 in accordance with the privacy timer value (e.g., based on an expiration of the privacy timer value).

At 455, the first UE 115-f may identify an expiration of a validity timer associated with the UE policy configuration, UAV services, or both. The validity timer(s) may be configured via the control signaling at 405, via additional control signaling, or both. The expiration of the validity timer may indicate that the UE policy configuration is no longer valid, or that the first UE 115-f is no longer authorized to perform the respective UAV services. As such, the first UE 115-f may refrain from performing UAV services/U2X communications following the expiration of the validity timer.

Techniques described herein may enable registration procedures between UEs 115 (e.g., UAVs) and the network which are used to configure U2X parameters at the UEs 115, in particular, techniques described herein enable UEs 115 to be efficiently configured with U2X parameters which may be used to support sidelink communications used for U2X services. In this regard, techniques described herein support signaling between UEs 115 and the network which enables the network to register and update subscription data for the UEs 115 associated with U2X services, thereby enabling efficient and widespread use of U2X services.

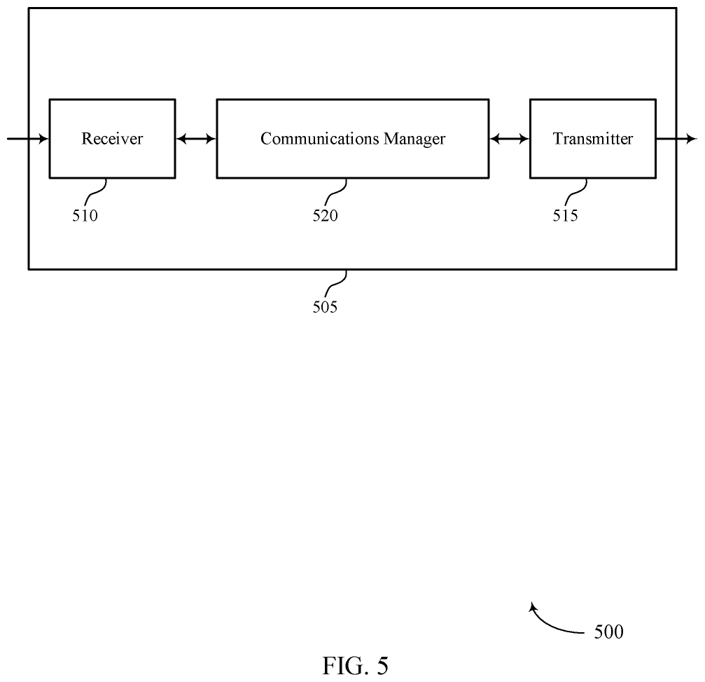

FIG. 5 shows a block diagram 500 of a device 505 that supports techniques for provisioning U2X parameters in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for provisioning U2X parameters). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for provisioning U2X parameters). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for provisioning U2X parameters as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving control signaling indicating a UE policy configuration including a set of radio parameters usable by the UE to perform sidelink communications to support one or more UAV services. The communications manager 520 may be configured as or otherwise support a means for receiving, via the control signaling, additional control signaling, or both, an altitude limitation parameter associated with the one or more UAV services. The communications manager 520 may be configured as or otherwise support a means for communicating a sidelink message associated with the one or more UAV services in accordance with the UE policy configuration and altitude limitation parameter.

By including or configuring the communications manager 520 in accordance with examples as described herein, the device 505 (e.g., a processor controlling or otherwise coupled with the receiver 510, the transmitter 515, the communications manager 520, or a combination thereof) may support techniques which enable registration procedures between UEs 115 (e.g., UAVs) and the network which are used to configure U2X parameters at the UEs 115, in particular, techniques described herein enable UEs 115 to be efficiently configured with U2X parameters which may be used to support sidelink communications used for U2X services. In this regard, techniques described herein support signaling between UEs 115 and the network which enables the network to register and update subscription data for the UEs 115 associated with U2X services, thereby enabling efficient and widespread use of U2X services.

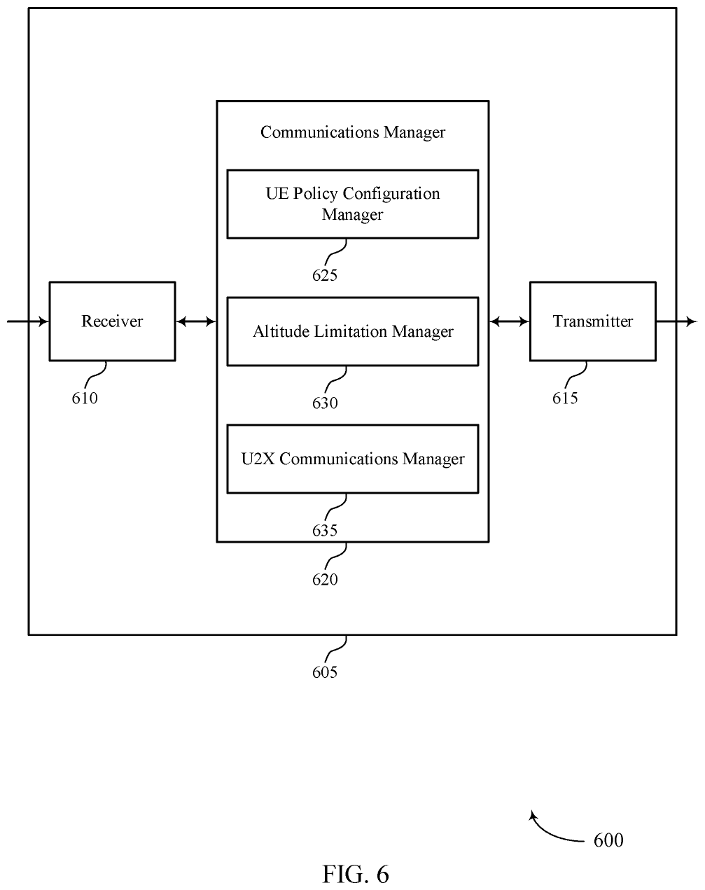

FIG. 6 shows a block diagram 600 of a device 605 that supports techniques for provisioning U2X parameters in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for provisioning U2X parameters). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for provisioning U2X parameters). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for provisioning U2X parameters as described herein. For example, the communications manager 620 may include a UE policy configuration manager 625, an altitude limitation manager 630, a U2X communications manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The UE policy configuration manager 625 may be configured as or otherwise support a means for receiving control signaling indicating a UE policy configuration including a set of radio parameters usable by the UE to perform sidelink communications to support one or more UAV services. The altitude limitation manager 630 may be configured as or otherwise support a means for receiving, via the control signaling, additional control signaling, or both, an altitude limitation parameter associated with the one or more UAV services. The U2X communications manager 635 may be configured as or otherwise support a means for communicating a sidelink message associated with the one or more UAV services in accordance with the UE policy configuration and altitude limitation parameter.

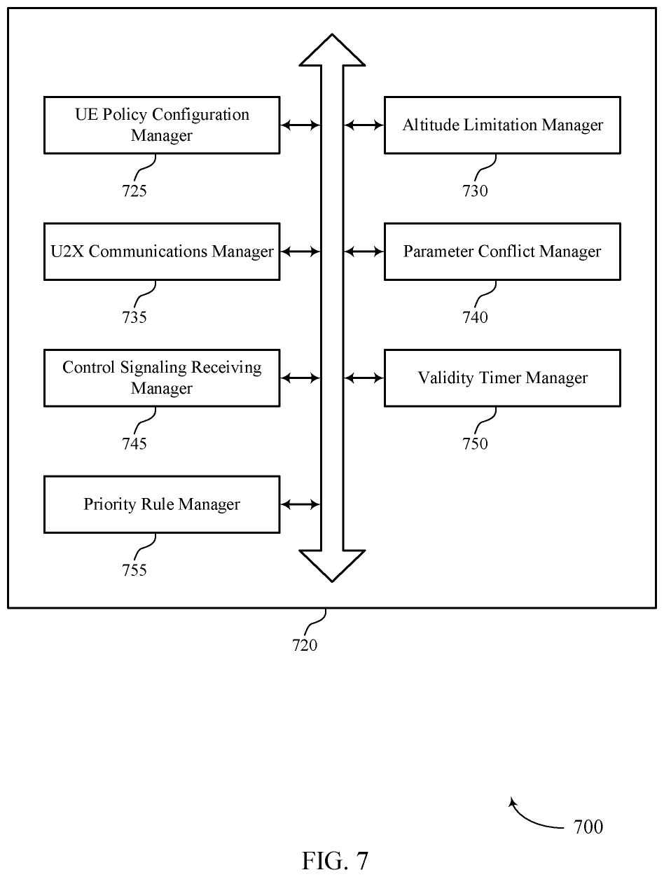

FIG. 7 shows a block diagram 700 of a communications manager 720 that supports techniques for provisioning U2X parameters in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for provisioning U2X parameters as described herein. For example, the communications manager 720 may include a UE policy configuration manager 725, an altitude limitation manager 730, a U2X communications manager 735, a parameter conflict manager 740, a control signaling receiving manager 745, a validity timer manager 750, a priority rule manager 755, or any combination thereof. Each of these components may communicate, directly or indirectly, with one another (e.g., via one or more buses).

The communications manager 720 may support wireless communication at a UE in accordance with examples as disclosed herein. The UE policy configuration manager 725 may be configured as or otherwise support a means for receiving control signaling indicating a UE policy configuration including a set of radio parameters usable by the UE to perform sidelink communications to support one or more UAV services. The altitude limitation manager 730 may be configured as or otherwise support a means for receiving, via the control signaling, additional control signaling, or both, an altitude limitation parameter associated with the one or more UAV services. The U2X communications manager 735 may be configured as or otherwise support a means for communicating a sidelink message associated with the one or more UAV services in accordance with the UE policy configuration and altitude limitation parameter.

In some examples, the altitude limitation manager 730 may be configured as or otherwise support a means for identifying an altitude associated with the UE, where communicating the sidelink message is based on the identified altitude satisfying the altitude limitation parameter. In some examples, the altitude limitation parameter includes an altitude range associated with an authorization for the one or more UAV services. In some examples, the identified altitude satisfies the altitude limitation parameter if the identified altitude is within the altitude range.

In some examples, the parameter conflict manager 740 may be configured as or otherwise support a means for identifying a conflict between a first radio parameter from the set of radio parameters and a second radio parameter from an additional set of radio parameters. In some examples, the U2X communications manager 735 may be configured as or otherwise support a means for communicating the sidelink message in accordance with the first radio parameter based on a priority rule associated with conflicts between the set of radio parameters and the additional set of radio parameters.

In some examples, the priority rule manager 755 may be configured as or otherwise support a means for receiving, via the control signaling, the additional control signaling, or both, an indication of one or more priority rules associated with conflicts between the set of radio parameters and one or more additional radio parameters, the one or more priority rules including the priority rule, where identifying the conflict, communicating the sidelink message, or both, are based on the one or more priority rules.

In some examples, the one or more priority rules are associated with a first source of the set of radio parameters and a second source of the additional set of radio parameters. In some examples, the one or more priority rules prioritize radio parameters provided by a policy control function over radio parameters provided by an application server, prioritize radio parameters provided by the application server over radio parameters provided by a SIM, and prioritize radio parameters provided by the SIM over radio parameters configured at the UE.

In some examples, the U2X communications manager 735 may be configured as or otherwise support a means for identifying an additional set of radio parameters usable by the UE to perform sidelink communications to support the one or more UAV services based on a SIM associated with the UE, where communicating the sidelink message is based on the additional set of radio parameters.

In some examples, the control signaling receiving manager 745 may be configured as or otherwise support a means for receiving, via the control signaling, the additional control signaling, or both, an indication of one or more RATs associated with the UE policy configuration, where the sidelink message is communicated in accordance with the one or more RATs.

In some examples, the control signaling receiving manager 745 may be configured as or otherwise support a means for receiving, via the control signaling, the additional control signaling, or both, an authorization to perform the one or more UAV services in accordance with the UE policy configuration and the one or more RATs, where the one or more RATs include a 4G RAT, an LTE RAT, a 5G RAT, an NR RAT, or any combination thereof, and where communicating the sidelink message is based on the authorization.

In some examples, the control signaling receiving manager 745 may be configured as or otherwise support a means for receiving, via the control signaling, the additional control signaling, or both, a first authorization for the UE to perform the one or more UAV services in accordance with the UE policy configuration during time intervals in which the UE is connected to a serving network, a second authorization for the UE to perform the one or more UAV services in accordance with the UE policy configuration during time intervals in which the UE is not connected to the serving network, or both, where communicating the sidelink message is based on the first authorization, the second authorization, or both.

In some examples, the control signaling receiving manager 745 may be configured as or otherwise support a means for receiving, via the control signaling, the additional control signaling, or both, an indication of one or more RATs associated with the one or more UAV services, where the sidelink message is communicated in accordance with the one or more RATs.

In some examples, the control signaling receiving manager 745 may be configured as or otherwise support a means for receiving, via the control signaling, the additional control signaling, or both, an indication of a first RAT associated with a first subset of the one or more UAV services, and a second RAT associated with a second subset of the one or more UAV services, where the one or more RATs include the first and second RAT.

In some examples, the control signaling receiving manager 745 may be configured as or otherwise support a means for receiving, via the control signaling, the additional control signaling, or both, an indication of one or more privacy parameters associated with the one or more UAV services, one or more geographical areas, or both, where the sidelink message is communicated in accordance with the one or more privacy parameters.

In some examples, the control signaling receiving manager 745 may be configured as or otherwise support a means for receiving, via the control signaling, the additional control signaling, or both, an indication of a privacy timer value associated with the UE policy configuration, where the sidelink message is communicated in accordance with the privacy timer value.

In some examples, the validity timer manager 750 may be configured as or otherwise support a means for receiving, via the control signaling, the additional control signaling, or both, an indication of a validity timer associated with the UE policy configuration, the set of radio parameters, or both, where communicating the sidelink message is based on the validity timer.

In some examples, the validity timer manager 750 may be configured as or otherwise support a means for identifying an expiration of the validity timer. In some examples, the U2X communications manager 735 may be configured as or otherwise support a means for refraining from performing sidelink communications in accordance with the UE policy configuration based on the expiration of the validity timer.

In some examples, the control signaling receiving manager 745 may be configured as or otherwise support a means for receiving, via the control signaling, the additional control signaling, or both, an indication of a set of mappings between the one or more UAV services and corresponding subsets of the set of radio parameters, where each subset of the set of radio parameters includes at least one of a frequency range, a geographical area, an altitude range, a mode of communication, an L2 identifier, a sidelink quality of service metric, a radio bearer, a discontinuous reception cycle, or any combination thereof, where communicating the sidelink message is based on the set of mappings.

In some examples, the control signaling receiving manager 745 may be configured as or otherwise support a means for receiving the control signaling, the additional control signaling, or both, from at least one of a network device or a second UE. In some examples, the control signaling receiving manager 745 may be configured as or otherwise support a means for receiving, via the control signaling, the additional control signaling, or both, an indication as to whether the set of radio parameters are operator-managed, non-operator-managed, or both, where communicating the sidelink message is based on the indication. In some examples, one or more UAV services include one or more U2X communications services.

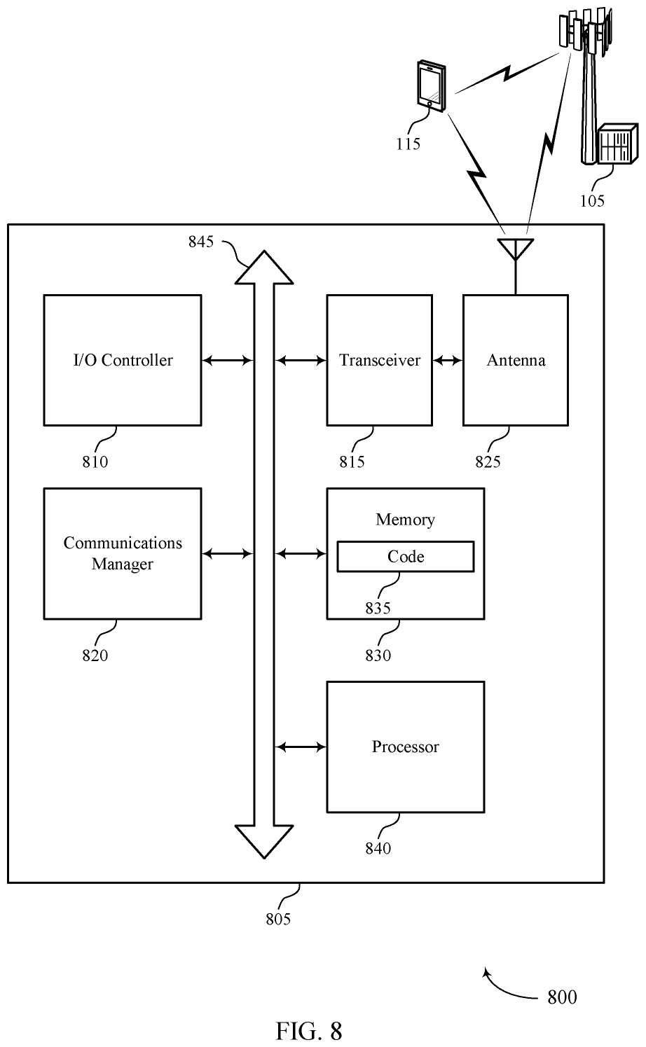

FIG. 8 shows a diagram of a system 800 including a device 805 that supports techniques for provisioning U2X parameters in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for provisioning U2X parameters). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving control signaling indicating a UE policy configuration including a set of radio parameters usable by the UE to perform sidelink communications to support one or more UAV services. The communications manager 820 may be configured as or otherwise support a means for receiving, via the control signaling, additional control signaling, or both, an altitude limitation parameter associated with the one or more UAV services. The communications manager 820 may be configured as or otherwise support a means for communicating a sidelink message associated with the one or more UAV services in accordance with the UE policy configuration and altitude limitation parameter.

By including or configuring the communications manager 820 in accordance with examples as described herein, the device 805 may support techniques which enable registration procedures between UEs 115 (e.g., UAVs) and the network which are used to configure U2X parameters at the UEs 115, in particular, techniques described herein enable UEs 115 to be efficiently configured with U2X parameters which may be used to support sidelink communications used for U2X services. In this regard, techniques described herein support signaling between UEs 115 and the network which enables the network to register and update subscription data for the UEs 115 associated with U2X services, thereby enabling efficient and widespread use of U2X services.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for provisioning U2X parameters as described herein, or the processor 840 and the memory 830 may be otherwise configured to perform or support such operations.

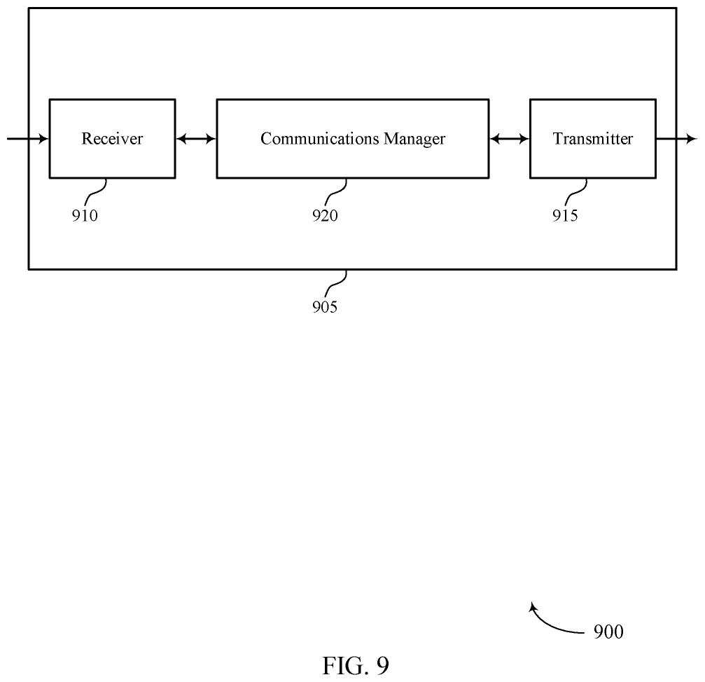

FIG. 9 shows a block diagram 900 of a device 905 that supports techniques for provisioning U2X parameters in accordance with one or more aspects of the present disclosure. The device 905 may be an example of aspects of a Network node as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for provisioning U2X parameters). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for provisioning U2X parameters). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for provisioning U2X parameters as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 may be configured as or otherwise support a means for transmitting, to a UE, control signaling indicating a UE policy configuration including a set of radio parameters usable by the UE to perform sidelink communications to support one or more UAV services. The communications manager 920 may be configured as or otherwise support a means for transmitting, via the control signaling, additional control signaling, or both, an altitude limitation parameter associated with the one or more UAV services. The communications manager 920 may be configured as or otherwise support a means for updating a subscription associated with the UE based on the altitude limitation parameter.

By including or configuring the communications manager 920 in accordance with examples as described herein, the device 905 (e.g., a processor controlling or otherwise coupled with the receiver 910, the transmitter 915, the communications manager 920, or a combination thereof) may support techniques which enable registration procedures between UEs 115 (e.g., UAVs) and the network which are used to configure U2X parameters at the UEs 115, in particular, techniques described herein enable UEs 115 to be efficiently configured with U2X parameters which may be used to support sidelink communications used for U2X services. In this regard, techniques described herein support signaling between UEs 115 and the network which enables the network to register and update subscription data for the UEs 115 associated with U2X services, thereby enabling efficient and widespread use of U2X services.

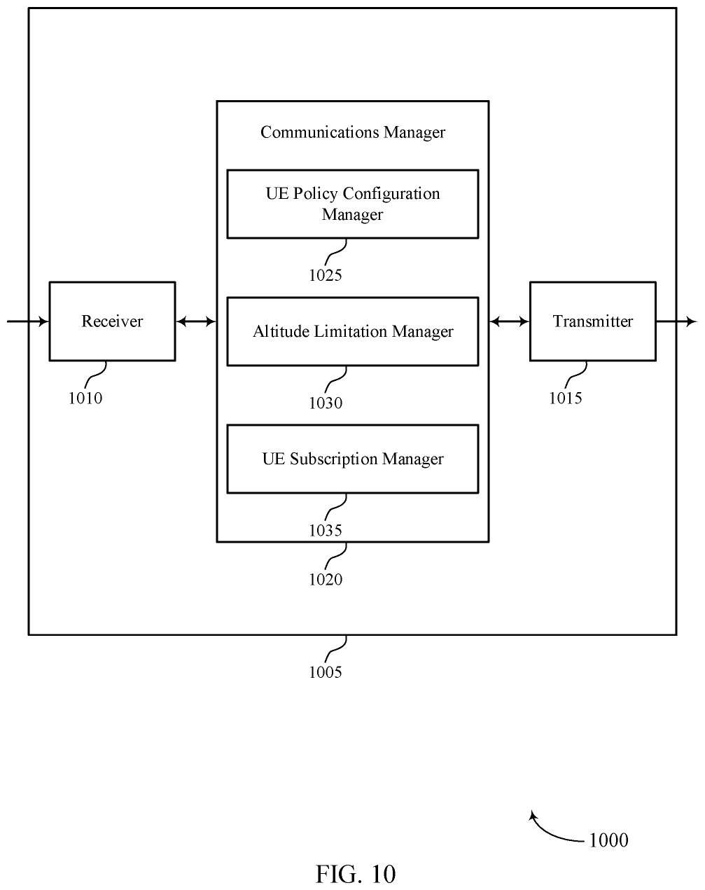

FIG. 10 shows a block diagram 1000 of a device 1005 that supports techniques for provisioning U2X parameters in accordance with one or more aspects of the present disclosure. The device 1005 may be an example of aspects of a device 905 or a network node as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for provisioning U2X parameters). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for provisioning U2X parameters). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for provisioning U2X parameters as described herein. For example, the communications manager 1020 may include a UE policy configuration manager 1025, an altitude limitation manager 1030, a UE subscription manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The UE policy configuration manager 1025 may be configured as or otherwise support a means for transmitting, to a UE, control signaling indicating a UE policy configuration including a set of radio parameters usable by the UE to perform sidelink communications to support one or more UAV services. The altitude limitation manager 1030 may be configured as or otherwise support a means for transmitting, via the control signaling, additional control signaling, or both, an altitude limitation parameter associated with the one or more UAV services. The UE subscription manager 1035 may be configured as or otherwise support a means for updating a subscription associated with the UE based on the altitude limitation parameter.

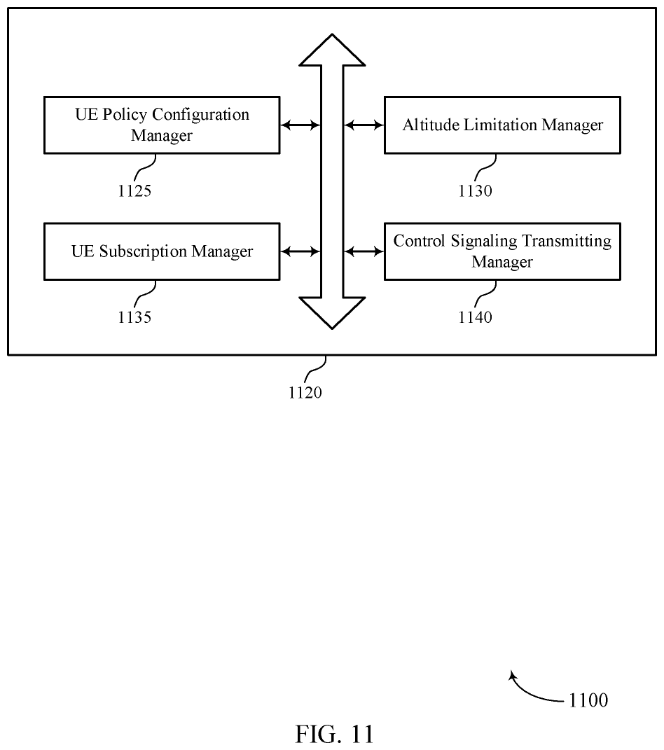

FIG. 11 shows a block diagram 1100 of a communications manager 1120 that supports techniques for provisioning U2X parameters in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for provisioning U2X parameters as described herein. For example, the communications manager 1120 may include a UE policy configuration manager 1125, an altitude limitation manager 1130, a UE subscription manager 1135, a control signaling transmitting manager 1140, or any combination thereof. Each of these components may communicate, directly or indirectly, with one another (e.g., via one or more buses).

The communications manager 1120 may support wireless communication in accordance with examples as disclosed herein. The UE policy configuration manager 1125 may be configured as or otherwise support a means for transmitting, to a UE, control signaling indicating a UE policy configuration including a set of radio parameters usable by the UE to perform sidelink communications to support one or more UAV services. The altitude limitation manager 1130 may be configured as or otherwise support a means for transmitting, via the control signaling, additional control signaling, or both, an altitude limitation parameter associated with the one or more UAV services. The UE subscription manager 1135 may be configured as or otherwise support a means for updating a subscription associated with the UE based on the altitude limitation parameter.

In some examples, the altitude limitation parameter includes an altitude range associated with an authorization for the one or more UAV services. In some examples, an altitude associated with the UE satisfies the altitude limitation parameter if the altitude is within the altitude range.

In some examples, the control signaling transmitting manager 1140 may be configured as or otherwise support a means for transmitting, via the control signaling, the additional control signaling, or both, an indication of one or more priority rules associated with conflicts between the set of radio parameters and one or more additional radio parameters.

In some examples, the one or more priority rules are associated with a first source of the set of radio parameters and a second source of the additional set of radio parameters. In some examples, the one or more priority rules prioritize radio parameters provided by a policy control function over radio parameters provided by an application server, prioritize radio parameters provided by the application server over radio parameters provided by a SIM, and prioritize radio parameters provided by the SIM over radio parameters configured at the UE.

In some examples, the control signaling transmitting manager 1140 may be configured as or otherwise support a means for transmitting, via the control signaling, the additional control signaling, or both, an indication of one or more RATs associated with the UE policy configuration.

In some examples, the control signaling transmitting manager 1140 may be configured as or otherwise support a means for transmitting, via the control signaling, the additional control signaling, or both, an authorization to perform the one or more UAV services in accordance with the UE policy configuration and the one or more RATs, where the one or more RATs include a 4G RAT, an LTE RAT, a 5G RAT, an NR RAT, or any combination thereof.

In some examples, the control signaling transmitting manager 1140 may be configured as or otherwise support a means for transmitting, via the control signaling, the additional control signaling, or both, a first authorization for the UE to perform the one or more UAV services in accordance with the UE policy configuration during time intervals in which the UE is connected to a serving network, a second authorization for the UE to perform the one or more UAV services in accordance with the UE policy configuration during time intervals in which the UE is not connected to the serving network, or both.

In some examples, the control signaling transmitting manager 1140 may be configured as or otherwise support a means for transmitting, via the control signaling, the additional control signaling, or both, an indication of one or more RATs associated with the one or more UAV services.

In some examples, the control signaling transmitting manager 1140 may be configured as or otherwise support a means for transmitting, via the control signaling, the additional control signaling, or both, an indication of a first RAT associated with a first subset of the one or more UAV services, and a second RAT associated with a second subset of the one or more UAV services, where the one or more RATs include the first and second RAT.

In some examples, the control signaling transmitting manager 1140 may be configured as or otherwise support a means for receiving, via the control signaling, the additional control signaling, or both, an indication of one or more privacy parameters associated with the one or more UAV services, one or more geographical areas, or both, where the sidelink message is communicated in accordance with the one or more privacy parameters.

In some examples, the control signaling transmitting manager 1140 may be configured as or otherwise support a means for transmitting, via the control signaling, the additional control signaling, or both, an indication of a privacy timer value associated with the UE policy configuration.

In some examples, the control signaling transmitting manager 1140 may be configured as or otherwise support a means for transmitting, via the control signaling, the additional control signaling, or both, an indication of a validity timer associated with the UE policy configuration, the set of radio parameters, or both.

In some examples, the control signaling transmitting manager 1140 may be configured as or otherwise support a means for transmitting, via the control signaling, the additional control signaling, or both, an indication of a set of mappings between the one or more UAV services and corresponding subsets of the set of radio parameters, where each subset of the set of radio parameters includes at least one of a frequency range, a geographical area, an altitude range, a mode of communication, an L2 identifier, a sidelink quality of service metric, a radio bearer, a discontinuous reception cycle, or any combination thereof, where communicating the sidelink message is based on the set of mappings.

In some examples, the control signaling transmitting manager 1140 may be configured as or otherwise support a means for transmitting, via the control signaling, the additional control signaling, or both, an indication as to whether the set of radio parameters are operator-managed, non-operator-managed, or both. In some examples, one or more UAV services include one or more U2X communications services.

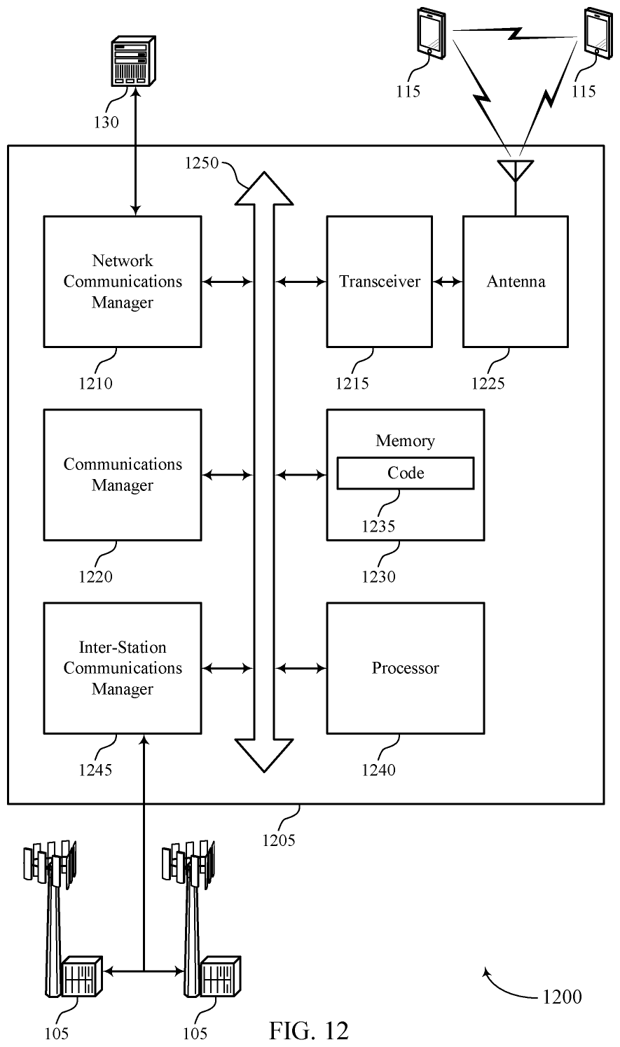

FIG. 12 shows a diagram of a system 1200 including a device 1205 that supports techniques for provisioning U2X parameters in accordance with one or more aspects of the present disclosure. The device 1205 may be an example of or include the components of a device 905, a device 1005, or a Network node as described herein. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for provisioning U2X parameters). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations or network entities 105, and may include a controller or scheduler for controlling communications with UEs 115 in cooperation with other base stations or network entities 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations or network entities 105.

The communications manager 1220 may support wireless communication in accordance with examples as disclosed herein. For example, the communications manager 1220 may be configured as or otherwise support a means for transmitting, to a UE, control signaling indicating a UE policy configuration including a set of radio parameters usable by the UE to perform sidelink communications to support one or more UAV services. The communications manager 1220 may be configured as or otherwise support a means for transmitting, via the control signaling, additional control signaling, or both, an altitude limitation parameter associated with the one or more UAV services. The communications manager 1220 may be configured as or otherwise support a means for updating a subscription associated with the UE based on the altitude limitation parameter.

By including or configuring the communications manager 1220 in accordance with examples as described herein, the device 1205 may support techniques which enable registration procedures between UEs 115 (e.g., UAVs) and the network which are used to configure U2X parameters at the UEs 115, in particular, techniques described herein enable UEs 115 to be efficiently configured with U2X parameters which may be used to support sidelink communications used for U2X services. In this regard, techniques described herein support signaling between UEs 115 and the network which enables the network to register and update subscription data for the UEs 115 associated with U2X services, thereby enabling efficient and widespread use of U2X services.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for provisioning U2X parameters as described herein, or the processor 1240 and the memory 1230 may be otherwise configured to perform or support such operations.

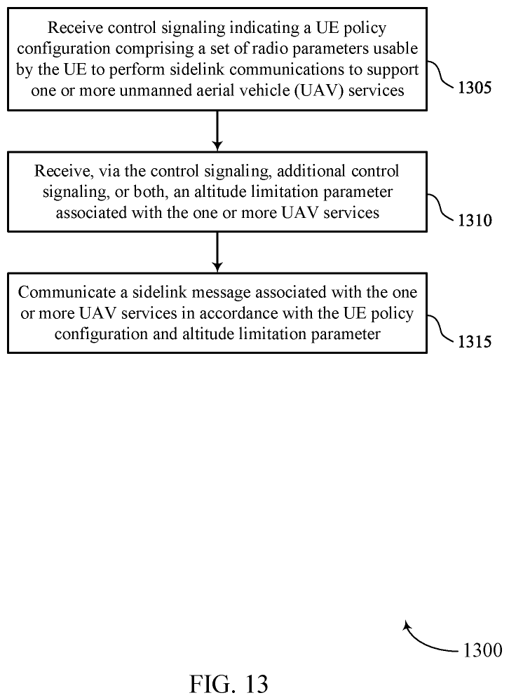

FIG. 13 shows a flowchart illustrating a method 1300 that supports techniques for provisioning U2X parameters in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating a UE policy configuration including a set of radio parameters usable by the UE to perform sidelink communications to support one or more UAV services. The operations of 1305 may be performed in accordance with examples as disclosed herein. In some examples, aspects of the operations of 1305 may be performed by a UE policy configuration manager 725 as described with reference to FIG. 7.

At 1310, the method may include receiving, via the control signaling, additional control signaling, or both, an altitude limitation parameter associated with the one or more UAV services. The operations of 1310 may be performed in accordance with examples as disclosed herein. In some examples, aspects of the operations of 1310 may be performed by an altitude limitation manager 730 as described with reference to FIG. 7.

At 1315, the method may include communicating a sidelink message associated with the one or more UAV services in accordance with the UE policy configuration and altitude limitation parameter. The operations of 1315 may be performed in accordance with examples as disclosed herein. In some examples, aspects of the operations of 1315 may be performed by a U2X communications manager 735 as described with reference to FIG. 7.

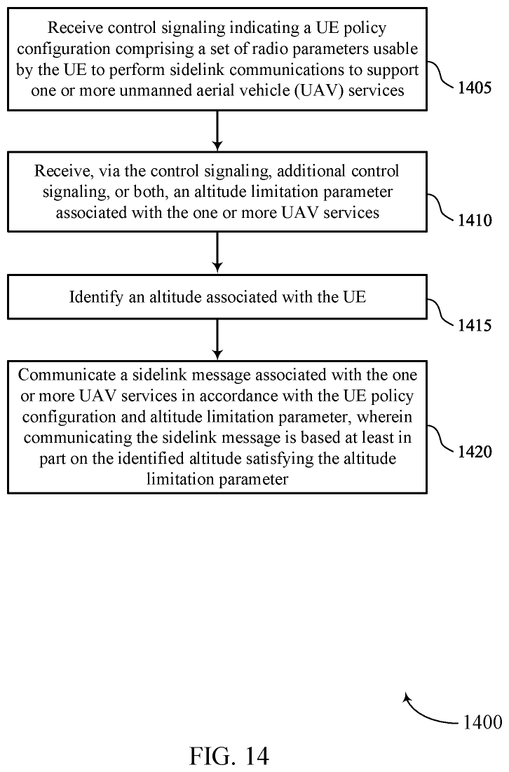

FIG. 14 shows a flowchart illustrating a method 1400 that supports techniques for provisioning U2X parameters in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a UE policy configuration including a set of radio parameters usable by the UE to perform sidelink communications to support one or more UAV services. The operations of 1405 may be performed in accordance with examples as disclosed herein. In some examples, aspects of the operations of 1405 may be performed by a UE policy configuration manager 725 as described with reference to FIG. 7.

At 1410, the method may include receiving, via the control signaling, additional control signaling, or both, an altitude limitation parameter associated with the one or more UAV services. The operations of 1410 may be performed in accordance with examples as disclosed herein. In some examples, aspects of the operations of 1410 may be performed by an altitude limitation manager 730 as described with reference to FIG. 7.

At 1415, the method may include identifying an altitude associated with the UE. The operations of 1415 may be performed in accordance with examples as disclosed herein. In some examples, aspects of the operations of 1415 may be performed by an altitude limitation manager 730 as described with reference to FIG. 7.

At 1420, the method may include communicating a sidelink message associated with the one or more UAV services in accordance with the UE policy configuration and altitude limitation parameter, where communicating the sidelink message is based on the identified altitude satisfying the altitude limitation parameter. The operations of 1420 may be performed in accordance with examples as disclosed herein. In some examples, aspects of the operations of 1420 may be performed by a U2X communications manager 735 as described with reference to FIG. 7.

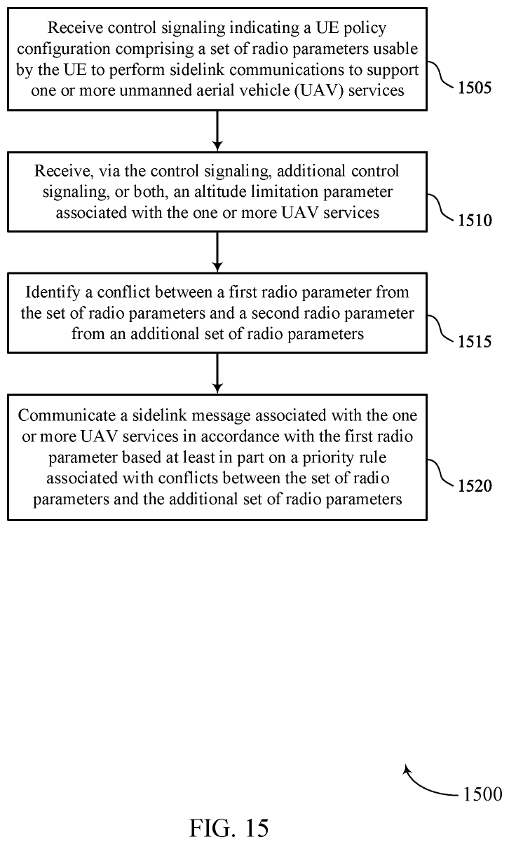

FIG. 15 shows a flowchart illustrating a method 1500 that supports techniques for provisioning U2X parameters in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving control signaling indicating a UE policy configuration including a set of radio parameters usable by the UE to perform sidelink communications to support one or more UAV services. The operations of 1505 may be performed in accordance with examples as disclosed herein. In some examples, aspects of the operations of 1505 may be performed by a UE policy configuration manager 725 as described with reference to FIG. 7.

At 1510, the method may include receiving, via the control signaling, additional control signaling, or both, an altitude limitation parameter associated with the one or more UAV services. The operations of 1510 may be performed in accordance with examples as disclosed herein. In some examples, aspects of the operations of 1510 may be performed by an altitude limitation manager 730 as described with reference to FIG. 7.

At 1515, the method may include identifying a conflict between a first radio parameter from the set of radio parameters and a second radio parameter from an additional set of radio parameters. The operations of 1515 may be performed in accordance with examples as disclosed herein. In some examples, aspects of the operations of 1515 may be performed by a parameter conflict manager 740 as described with reference to FIG. 7.

At 1520, the method may include communicating a sidelink message associated with the one or more UAV services in accordance with the first radio parameter based on a priority rule associated with conflicts between the set of radio parameters and the additional set of radio parameters. The operations of 1520 may be performed in accordance with examples as disclosed herein. In some examples, aspects of the operations of 1520 may be performed by a U2X communications manager 735 as described with reference to FIG. 7.

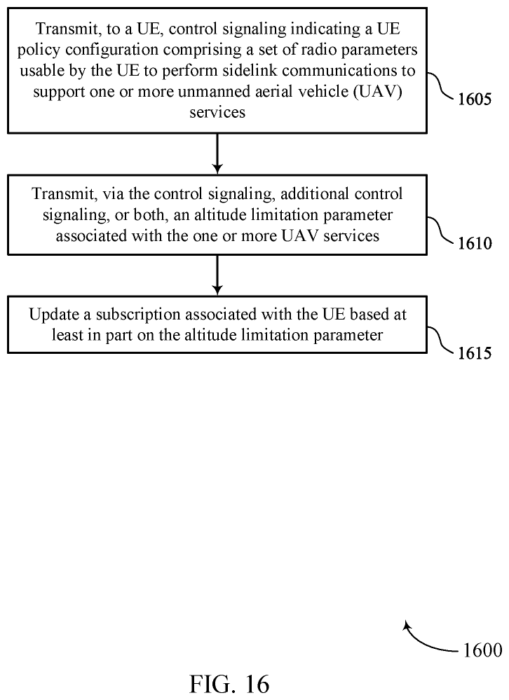

FIG. 16 shows a flowchart illustrating a method 1600 that supports techniques for provisioning U2X parameters in accordance with one or more aspects of the present disclosure. The operations of the method 1600 may be implemented by a Network node or its components as described herein. For example, the operations of the method 1600 may be performed by a Network node as described with reference to FIGS. 1 through 4 and 9 through 12. In some examples, a Network node may execute a set of instructions to control the functional elements of the Network node to perform the described functions. Additionally, or alternatively, the Network node may perform aspects of the described functions using special-purpose hardware.

At 1605, the method may include transmitting, to a UE, control signaling indicating a UE policy configuration including a set of radio parameters usable by the UE to perform sidelink communications to support one or more UAV services. The operations of 1605 may be performed in accordance with examples as disclosed herein. In some examples, aspects of the operations of 1605 may be performed by a UE policy configuration manager 1125 as described with reference to FIG. 11.

At 1610, the method may include transmitting, via the control signaling, additional control signaling, or both, an altitude limitation parameter associated with the one or more UAV services. The operations of 1610 may be performed in accordance with examples as disclosed herein. In some examples, aspects of the operations of 1610 may be performed by an altitude limitation manager 1130 as described with reference to FIG. 11.

At 1615, the method may include updating a subscription associated with the UE based on the altitude limitation parameter. The operations of 1615 may be performed in accordance with examples as disclosed herein. In some examples, aspects of the operations of 1615 may be performed by a UE subscription manager 1135 as described with reference to FIG. 11.

The following provides an overview of aspects of the present disclosure:

Aspect 1: A method for wireless communication at a UE, comprising: receiving control signaling indicating a UE policy configuration comprising a set of radio parameters usable by the UE to perform sidelink communications to support one or more UAV services: receiving, via the control signaling, additional control signaling, or both, an altitude limitation parameter associated with the one or more UAV services; and communicating a sidelink message associated with the one or more UAV services in accordance with the UE policy configuration and altitude limitation parameter.

Aspect 2: The method of aspect 1, further comprising: identifying an altitude associated with the UE, wherein communicating the sidelink message is based at least in part on the identified altitude satisfying the altitude limitation parameter.

Aspect 3: The method of aspect 2, wherein the altitude limitation parameter comprises an altitude range associated with an authorization for the one or more UAV services, and the identified altitude satisfies the altitude limitation parameter if the identified altitude is within the altitude range.

Aspect 4: The method of any of aspects 1 through 3, further comprising: identifying a conflict between a first radio parameter from the set of radio parameters and a second radio parameter from an additional set of radio parameters; and communicating the sidelink message in accordance with the first radio parameter based at least in part on a priority rule associated with conflicts between the set of radio parameters and the additional set of radio parameters.

Aspect 5: The method of aspect 4, further comprising: receiving, via the control signaling, the additional control signaling, or both, an indication of one or more priority rules associated with conflicts between the set of radio parameters one or more additional radio parameters, the one or more priority rules including the priority rule, wherein identifying the conflict, communicating the sidelink message, or both, are based at least in part on the one or more priority rules.

Aspect 6: The method of aspect 5, wherein the one or more priority rules are associated with a first source of the set of radio parameters and a second source of the additional set of radio parameters, the one or more priority rules prioritize radio parameters provided by a policy control function over radio parameters provided by an application server, prioritize radio parameters provided by the application server over radio parameters provided by a SIM, and prioritize radio parameters provided by the SIM over radio parameters configured at the UE.

Aspect 7: The method of any of aspects 1 through 6, further comprising: identifying an additional set of radio parameters usable by the UE to perform sidelink communications to support the one or more UAV services based at least in part on a SIM associated with the UE, wherein communicating the sidelink message is based at least in part on the additional set of radio parameters.

Aspect 8: The method of any of aspects 1 through 7, further comprising: receiving, via the control signaling, the additional control signaling, or both, an indication of one or more RATs associated with the UE policy configuration, wherein the sidelink message is communicated in accordance with the one or more RATs.

Aspect 9: The method of aspect 8, further comprising: receiving, via the control signaling, the additional control signaling, or both, an authorization to perform the one or more UAV services in accordance with the UE policy configuration and the one or more RATs, wherein the one or more RATs comprise a 4G RAT, an LTE RAT, a 5G RAT, an NR RAT, or any combination thereof, and wherein communicating the sidelink message is based at least in part on the authorization.

Aspect 10: The method of any of aspects 1 through 9, further comprising: receiving, via the control signaling, the additional control signaling, or both, a first authorization for the UE to perform the one or more UAV services in accordance with the UE policy configuration during time intervals in which the UE is connected to a serving network, a second authorization for the UE to perform the one or more UAV services in accordance with the UE policy configuration during time intervals in which the UE is not connected to the serving network, or both, wherein communicating the sidelink message is based at least in part on the first authorization, the second authorization, or both.

Aspect 11: The method of any of aspects 1 through 10, further comprising: receiving, via the control signaling, the additional control signaling, or both, an indication of one or more RATs associated with the one or more UAV services, wherein the sidelink message is communicated in accordance with the one or more RATs.

Aspect 12: The method of aspect 11, further comprising: receiving, via the control signaling, the additional control signaling, or both, an indication of a first RAT associated with a first subset of the one or more UAV services, and a second RAT associated with a second subset of the one or more UAV services, wherein the one or more RATs include the first and second RAT.

Aspect 13: The method of any of aspects 1 through 12, further comprising: receiving, via the control signaling, the additional control signaling, or both, an indication of one or more privacy parameters associated with the one or more UAV services, one or more geographical areas, or both, wherein the sidelink message is communicated in accordance with the one or more privacy parameters.

Aspect 14: The method of any of aspects 1 through 13, further comprising: receiving, via the control signaling, the additional control signaling, or both, an indication of a privacy timer value associated with the UE policy configuration, wherein the sidelink message is communicated in accordance with the privacy timer value.

Aspect 15: The method of any of aspects 1 through 14, further comprising: receiving, via the control signaling, the additional control signaling, or both, an indication of a validity timer associated with the UE policy configuration, the set of radio parameters, or both, wherein communicating the sidelink message is based at least in part on the validity timer.

Aspect 16: The method of aspect 15, further comprising: identifying an expiration of the validity timer; and refraining from performing sidelink communications in accordance with the UE policy configuration based at least in part on the expiration of the validity timer.

Aspect 17: The method of any of aspects 1 through 16, further comprising: receiving, via the control signaling, the additional control signaling, or both, an indication of a set of mappings between the one or more UAV services and corresponding subsets of the set of radio parameters, wherein each subset of the set of radio parameters comprises at least one of a frequency range, a geographical area, an altitude range, a mode of communication, an L2 identifier, a sidelink QoS metric, a radio bearer, a DRX cycle, or any combination thereof, wherein communicating the sidelink message is based at least in part on the set of mappings.

Aspect 18: The method of any of aspects 1 through 17, further comprising: receiving the control signaling, the additional control signaling, or both, from at least one of a network device or a second UE.

Aspect 19: The method of any of aspects 1 through 18, further comprising: receiving, via the control signaling, the additional control signaling, or both, an indication as to whether the set of radio parameters are operator-managed, non-operator-managed, or both, wherein communicating the sidelink message is based at least in part on the indication.

Aspect 20: The method of any of aspects 1 through 19, wherein one or more UAV services comprise one or more U2X communications services.

Aspect 21: A method for wireless communication, comprising: transmitting, to a UE, control signaling indicating a UE policy configuration comprising a set of radio parameters usable by the UE to perform sidelink communications to support one or more UAV services: transmitting, via the control signaling, additional control signaling, or both, an altitude limitation parameter associated with the one or more UAV services; and updating a subscription associated with the UE based at least in part on the altitude limitation parameter.

Aspect 22: The method of aspect 21, wherein the altitude limitation parameter comprises an altitude range associated with an authorization for the one or more UAV services, and an altitude associated with the UE satisfies the altitude limitation parameter if the altitude is within the altitude range.

Aspect 23: The method of any of aspects 21 through 22, further comprising: transmitting, via the control signaling, the additional control signaling, or both, an indication of one or more priority rules associated with conflicts between the set of radio parameters one or more additional radio parameters.

Aspect 24: The method of aspect 23, wherein the one or more priority rules are associated with a first source of the set of radio parameters and a second source of the additional set of radio parameters, the one or more priority rules prioritize radio parameters provided by a policy control function over radio parameters provided by an application server, prioritize radio parameters provided by the application server over radio parameters provided by a SIM, and prioritize radio parameters provided by the SIM over radio parameters configured at the UE.

Aspect 25: The method of any of aspects 21 through 24, further comprising: transmitting, via the control signaling, the additional control signaling, or both, an indication of one or more RATs associated with the UE policy configuration.

Aspect 26: The method of aspect 25, further comprising: transmitting, via the control signaling, the additional control signaling, or both, an authorization to perform the one or more UAV services in accordance with the UE policy configuration and the one or more RATs, wherein the one or more RATs comprise a 4G RAT, an LTE RAT, a 5G RAT, an NR RAT, or any combination thereof.

Aspect 27: The method of any of aspects 21 through 26, further comprising: transmitting, via the control signaling, the additional control signaling, or both, a first authorization for the UE to perform the one or more UAV services in accordance with the UE policy configuration during time intervals in which the UE is connected to a serving network, a second authorization for the UE to perform the one or more UAV services in accordance with the UE policy configuration during time intervals in which the UE is not connected to the serving network, or both.

Aspect 28: The method of any of aspects 21 through 27, further comprising: transmitting, via the control signaling, the additional control signaling, or both, an indication of one or more RATs associated with the one or more UAV services.

Aspect 29: The method of aspect 28, further comprising: transmitting, via the control signaling, the additional control signaling, or both, an indication of a first RAT associated with a first subset of the one or more UAV services, and a second RAT associated with a second subset of the one or more UAV services, wherein the one or more RATs include the first and second RAT.

Aspect 30: The method of any of aspects 21 through 29, further comprising: receiving, via the control signaling, the additional control signaling, or both, an indication of one or more privacy parameters associated with the one or more UAV services, one or more geographical areas, or both, wherein the sidelink message is communicated in accordance with the one or more privacy parameters.

Aspect 31: The method of any of aspects 21 through 30, further comprising: transmitting, via the control signaling, the additional control signaling, or both, an indication of a privacy timer value associated with the UE policy configuration.

Aspect 32: The method of any of aspects 21 through 31, further comprising: transmitting, via the control signaling, the additional control signaling, or both, an indication of a validity timer associated with the UE policy configuration, the set of radio parameters, or both.

Aspect 33: The method of any of aspects 21 through 32, further comprising: transmitting, via the control signaling, the additional control signaling, or both, an indication of a set of mappings between the one or more UAV services and corresponding subsets of the set of radio parameters, wherein each subset of the set of radio parameters comprises at least one of a frequency range, a geographical area, an altitude range, a mode of communication, an L2 identifier, a sidelink QoS metric, a radio bearer, a DRX cycle, or any combination thereof, wherein communicating the sidelink message is based at least in part on the set of mappings.

Aspect 34: The method of any of aspects 21 through 33, further comprising: transmitting, via the control signaling, the additional control signaling, or both, an indication as to whether the set of radio parameters are operator-managed, non-operator-managed, or both.

Aspect 35: The method of any of aspects 21 through 34, wherein one or more UAV services comprise one or more U2X communications services.

Aspect 36: An apparatus for wireless communication at a UE, comprising a processor: memory coupled with the processor; and instructions stored in the memory and executable by the processor to cause the apparatus to perform a method of any of aspects 1 through 20.

Aspect 37: An apparatus for wireless communication at a UE, comprising at least one means for performing a method of any of aspects 1 through 20.

Aspect 38: A non-transitory computer-readable medium storing code for wireless communication at a UE, the code comprising instructions executable by a processor to perform a method of any of aspects 1 through 20.

Aspect 39: An apparatus for wireless communication, comprising a processor; memory coupled with the processor; and instructions stored in the memory and executable by the processor to cause the apparatus to perform a method of any of aspects 21 through 35.

Aspect 40: An apparatus for wireless communication, comprising at least one means for performing a method of any of aspects 21 through 35.

Aspect 41: A non-transitory computer-readable medium storing code for wireless communication, the code comprising instructions executable by a processor to perform a method of any of aspects 21 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive control signaling indicating a UE policy configuration comprising a set of radio parameters usable by the UE to perform sidelink communications to support one or more unmanned aerial vehicle (UAV) services;
receive, via the control signaling, additional control signaling, or both, an altitude limitation parameter associated with the one or more UAV services; and
communicate a sidelink message associated with the one or more UAV services in accordance with the UE policy configuration and altitude limitation parameter.

2. The apparatus of claim 1, wherein the instructions are further executable by the processor to cause the apparatus to:
identify an altitude associated with the UE, wherein communicating the sidelink message is based at least in part on the identified altitude satisfying the altitude limitation parameter.

3. The apparatus of claim 2, wherein the altitude limitation parameter comprises an altitude range associated with an authorization for the one or more UAV services, and wherein the identified altitude satisfies the altitude limitation parameter if the identified altitude is within the altitude range.

4. The apparatus of claim 1, wherein the instructions are further executable by the processor to cause the apparatus to:
identify a conflict between a first radio parameter from the set of radio parameters and a second radio parameter from an additional set of radio parameters; and
communicate the sidelink message in accordance with the first radio parameter based at least in part on a priority rule associated with conflicts between the set of radio parameters and the additional set of radio parameters.

5. The apparatus of claim 4, wherein the instructions are further executable by the processor to cause the apparatus to:
receive, via the control signaling, the additional control signaling, or both, an indication of one or more priority rules associated with conflicts between the set of radio parameters and one or more additional radio parameters, the one or more priority rules including the priority rule, wherein identifying the conflict, communicating the sidelink message, or both, are based at least in part on the one or more priority rules.

6. The apparatus of claim 5, wherein the one or more priority rules are associated with a first source of the set of radio parameters and a second source of the additional set of radio parameters, and wherein the one or more priority rules prioritize radio parameters provided by a policy control function over radio parameters provided by an application server, prioritize radio parameters provided by the application server over radio parameters provided by a subscriber identification module, and prioritize radio parameters provided by the subscriber identification module over radio parameters configured at the UE.

7. The apparatus of claim 1, wherein the instructions are further executable by the processor to cause the apparatus to:
identify an additional set of radio parameters usable by the UE to perform sidelink communications to support the one or more UAV services based at least in part on a subscriber identification module associated with the UE, wherein communicating the sidelink message is based at least in part on the additional set of radio parameters.

8. The apparatus of claim 1, wherein the instructions are further executable by the processor to cause the apparatus to:
receive, via the control signaling, the additional control signaling, or both, an indication of one or more radio access technologies associated with the UE policy configuration, wherein the sidelink message is communicated in accordance with the one or more radio access technologies.

9. The apparatus of claim 8, wherein the instructions are further executable by the processor to cause the apparatus to:
receive, via the control signaling, the additional control signaling, or both, an authorization to perform the one or more UAV services in accordance with the UE policy configuration and the one or more radio access technologies, wherein the one or more radio access technologies comprise a Fourth Generation radio access technology, a Long-Term Evolution radio access technology, a Fifth Generation radio access technology, a New Radio access technology, or any combination thereof, and wherein communicating the sidelink message is based at least in part on the authorization.

10. The apparatus of claim 1, wherein the instructions are further executable by the processor to cause the apparatus to:
receive, via the control signaling, the additional control signaling, or both, a first authorization for the UE to perform the one or more UAV services in accordance with the UE policy configuration during time intervals in which the UE is connected to a serving network, a second authorization for the UE to perform the one or more UAV services in accordance with the UE policy configuration during time intervals in which the UE is not connected to the serving network, or both, wherein communicating the sidelink message is based at least in part on the first authorization, the second authorization, or both.

11. The apparatus of claim 1, wherein the instructions are further executable by the processor to cause the apparatus to:
receive, via the control signaling, the additional control signaling, or both, an indication of one or more radio access technologies associated with the one or more UAV services, wherein the sidelink message is communicated in accordance with the one or more radio access technologies.

12. The apparatus of claim 11, wherein the instructions are further executable by the processor to cause the apparatus to:
receive, via the control signaling, the additional control signaling, or both, an indication of a first radio access technology associated with a first subset of the one or more UAV services, and a second radio access technology associated with a second subset of the one or more UAV services, wherein the one or more radio access technologies include the first and second radio access technology.

13. The apparatus of claim 1, wherein the instructions are further executable by the processor to cause the apparatus to:
receive, via the control signaling, the additional control signaling, or both, an indication of one or more privacy parameters associated with the one or more UAV services, one or more geographical areas, or both, wherein the sidelink message is communicated in accordance with the one or more privacy parameters.

14. The apparatus of claim 1, wherein the instructions are further executable by the processor to cause the apparatus to:
receive, via the control signaling, the additional control signaling, or both, an indication of a privacy timer value associated with the UE policy configuration, wherein the sidelink message is communicated in accordance with the privacy timer value.

15. The apparatus of claim 1, wherein the instructions are further executable by the processor to cause the apparatus to:
receive, via the control signaling, the additional control signaling, or both, an indication of a validity timer associated with the UE policy configuration, the set of radio parameters, or both, wherein communicating the sidelink message is based at least in part on the validity timer.

16. The apparatus of claim 15, wherein the instructions are further executable by the processor to cause the apparatus to:
identify an expiration of the validity timer; and
refrain from performing sidelink communications in accordance with the UE policy configuration based at least in part on the expiration of the validity timer.

17. The apparatus of claim 1, wherein the instructions are further executable by the processor to cause the apparatus to:
receive, via the control signaling, the additional control signaling, or both, an indication of a set of mappings between the one or more UAV services and corresponding subsets of the set of radio parameters, wherein each subset of the set of radio parameters comprises at least one of a frequency range, a geographical area, an altitude range, a mode of communication, a Layer 2 identifier, a sidelink quality of service metric, a radio bearer, a discontinuous reception cycle, or any combination thereof, wherein communicating the sidelink message is based at least in part on the set of mappings.

18. The apparatus of claim 1, wherein the instructions are further executable by the processor to cause the apparatus to:
receive the control signaling, the additional control signaling, or both, from at least one of a network device or a second UE.

19. The apparatus of claim 1, wherein the instructions are further executable by the processor to cause the apparatus to:
receive, via the control signaling, the additional control signaling, or both, an indication as to whether the set of radio parameters are operator-managed, non-operator-managed, or both, wherein communicating the sidelink message is based at least in part on the indication.

20. The apparatus of claim 1, wherein one or more UAV services comprise one or more UAV-to-everything communications services.

21. An apparatus for wireless communication, comprising:
a processor;
memory coupled with the processor; and
instructions stored in the memory and executable by the processor to cause the apparatus to:
transmit control signaling indicating a user equipment (UE) policy configuration comprising a set of radio parameters usable by a UE to perform sidelink communications to support one or more unmanned aerial vehicle (UAV) services;
transmit, via the control signaling, additional control signaling, or both, an altitude limitation parameter associated with the one or more UAV services; and
update a subscription associated with the UE based at least in part on the altitude limitation parameter.

22. The apparatus of claim 21, wherein the altitude limitation parameter comprises an altitude range associated with an authorization for the one or more UAV services, and wherein an altitude associated with the UE satisfies the altitude limitation parameter if the altitude is within the altitude range.

23. The apparatus of claim 21, wherein the instructions are further executable by the processor to cause the apparatus to:
transmit, via the control signaling, the additional control signaling, or both, an indication of one or more priority rules associated with conflicts between the set of radio parameters and one or more additional radio parameters.

24. The apparatus of claim 23, wherein the one or more priority rules are associated with a first source of the set of radio parameters and a second source of the additional set of radio parameters, and wherein the one or more priority rules prioritize radio parameters provided by a policy control function over radio parameters provided by an application server, prioritize radio parameters provided by the application server over radio parameters provided by a subscriber identification module, and prioritize radio parameters provided by the subscriber identification module over radio parameters configured at the UE.

25. The apparatus of claim 21, wherein the instructions are further executable by the processor to cause the apparatus to:
transmit, via the control signaling, the additional control signaling, or both, an indication of one or more radio access technologies associated with the UE policy configuration.

26. The apparatus of claim 25, wherein the instructions are further executable by the processor to cause the apparatus to:
transmit, via the control signaling, the additional control signaling, or both, an authorization to perform the one or more UAV services in accordance with the UE policy configuration and the one or more radio access technologies, wherein the one or more radio access technologies comprise a Fourth Generation radio access technology, a Long-Term Evolution radio access technology, a Fifth Generation radio access technology, a New Radio access technology, or any combination thereof.

27. The apparatus of claim 21, wherein the instructions are further executable by the processor to cause the apparatus to:
transmit, via the control signaling, the additional control signaling, or both, a first authorization for the UE to perform the one or more UAV services in accordance with the UE policy configuration during time intervals in which the UE is connected to a serving network, a second authorization for the UE to perform the one or more UAV services in accordance with the UE policy configuration during time intervals in which the UE is not connected to the serving network, or both.

28. The apparatus of claim 21, wherein the instructions are further executable by the processor to cause the apparatus to:
transmit, via the control signaling, the additional control signaling, or both, an indication of one or more radio access technologies associated with the one or more UAV services.

29. A method for wireless communication at a user equipment (UE), comprising:
receiving control signaling indicating a UE policy configuration comprising a set of radio parameters usable by the UE to perform sidelink communications to support one or more unmanned aerial vehicle (UAV) services;
receiving, via the control signaling, additional control signaling, or both, an altitude limitation parameter associated with the one or more UAV services; and
communicating a sidelink message associated with the one or more UAV services in accordance with the UE policy configuration and altitude limitation parameter.

30. A method for wireless communication, comprising:
transmitting control signaling indicating a user equipment (UE) policy configuration comprising a set of radio parameters usable by a UE to perform sidelink communications to support one or more unmanned aerial vehicle (UAV) services;
transmitting, via the control signaling, additional control signaling, or both, an altitude limitation parameter associated with the one or more UAV services; and
updating a subscription associated with the UE based at least in part on the altitude limitation parameter.
